(19) United States
(12) Patent Application Publication
(10) Pub. No.: US 2026/0094448 A1
(43) Pub. Date: Apr. 2, 2026

(54) ELECTRONIC DEVICE AND ELECTRONIC SYSTEM FOR PERFORMING SITUATION DETERMINATION OPERATION ON BASIS OF OBJECT IDENTIFICATION BASED ON EDGE AI TECHNOLOGY

(71) Applicant: Byung Joon KIM, Seoul (KR)

(72) Inventor: Byung Joon KIM, Seoul (KR)

(21) Appl. No.: 19/202,929

(22) Filed: May 8, 2025

Related U.S. Application Data
(63) Continuation of application No. PCT/KR2023/017998, filed on Nov. 9, 2023.

(30) Foreign Application Priority Data
Nov. 9, 2022 (KR) 10-2022-0148338
Nov. 24, 2022 (KR) 10-2022-0159040
Nov. 24, 2022 (KR) 10-2022-0159041
Dec. 23, 2022 (KR) 10-2022-0182479

(51) Int. Cl. G06V 20/54; G06T 7/70; G06V 10/74; G06V 10/82; G06V 20/17; G06V 40/10

(52) U.S. Cl. CPC G06V 20/54; G06T 7/70; G06V 10/761; G06V 10/82; G06V 40/10; G06T 2207/10032; G06T 2207/10048; G06T 2207/20021; G06T 2207/20084; G06T 2207/30196; G06T 2207/30232; G06T 2207/30236; G06V 20/17; G06V 2201/08

(57) ABSTRACT

The present invention relates to an electronic device for performing a situation judgment operation based on information of an object, comprising: a memory; a processor, and a camera; wherein the processor directly processes an artificial intelligence model based on image processing, and the processor identifies information of the object by using an image of the object captured by the camera as an input of the artificial intelligence model based on image processing, and the processor performs the situation judgment operation based on information of the identified object.

### TECHNICAL FIELD

The present invention relates to an electronic device and an electronic system for performing a situation determination operation based on object identification based on edge AI technology.

### BACKGROUND ART

Accidents are likely to occur due to various reasons along the coast. Therefore, a system capable of immediately determining whether a person is currently in a dangerous situation through cameras or other means is needed.

The present invention proposes a technology capable of identifying whether a real moving person or an object having a shape of a person while identifying a person through artificial intelligence.

Nowadays, as parking lots in buildings are not limited to residents or visitors of the building but shared with all users, users may obtain parking spaces, and a manager of the building often makes a profit by using extra parking spaces.

Accordingly, the present invention proposes a device and a method capable of guiding a vehicle based on reservation information of a parking space.

Typically, forest fire detection has been done by people directly checking through general CCTVs that monitor mountains. Accordingly, immediate forest fire detection may be difficult, and it is practically impossible for people to check all the CCTVs.

Accordingly, the present invention proposes a technology to which edge AI is applied to detect forest fires through artificial intelligence so that delays due to data transmission speeds do not occur in emergency situations such as forest fires.

As the number of cars increases, a rate of traffic accidents is increasing significantly. Therefore, it is becoming important to clarify responsibility for the accident through objective fact-finding related to the accident. In general, when a traffic accident occurs, parties agree on whether there is negligence and percentage of negligence. Alternatively, the police are dispatched to inspect and record the accident situation, and determine whether there is negligence and the percentage of negligence by judging the situation at the time of the accident. However, this method has a problem in that the method does not accurately analyze the traffic accident situation and relies on the subjective judgment of the accident parties or police officers.

To improve these problems, an accident video analysis system and an analysis method using the same that determine the percentage of fault by comparing black box videos with similar accident videos are disclosed in Patent Document 1. However, the invention disclosed in Patent Document 1 still has a problem in that spatially limited images are used due to the black box videos, and standard traffic accident information may not be utilized.

In addition, currently installed and operating video surveillance devices are providing traffic information through analysis of real-time road images. However, real-time traffic accident status analysis based on traffic accidents is not being conducted.

### DISCLOSURE

### Technical Problem

The present invention provides a device for providing object identification and advance warning based on edge AI technology.

The present invention also provides a device and a method for providing an AI-based vehicle parking reservation and guidance service.

The present invention also provides a device and a method for providing edge AI-based forest fire precision detection and response.

The present invention also provides a traffic accident analysis system and a method for estimating similarity between actual traffic accident information and standard traffic accident information in order to solve the above-described problems.

### Technical Solution

An embodiment of the present invention provides an electronic device including a memory and a processor connected to the memory. The processor receives a photographed image from a camera installed along a target coast, identifies a person in the photographed image through an artificial intelligence module, and determines whether the person is in a dangerous situation based on a risk level based on a location and time at which the person is identified. When the processor determines that the person is in a dangerous situation, the processor visually displays and outputs the location of the person in the photographed image of the camera on a pre-installed display. The processor transmits information indicating that the person is in a dangerous situation to an operator terminal used by an operator operating the electronic device.

Here, the processor may control the camera to operate as a thermal imaging camera in weather with poor visibility, such as fog, or at night, based on weather information.

Here, the processor may divide the photographed image into a plurality of blocks each having a preset first block size. In addition, the processor may sequentially perform an object detection process on the plurality of blocks through an artificial intelligence module, thereby identifying the person.

Here, the processor may receive a first size of an object to be identified, and derive a second size in the case where the object exists in the photographed image based on the first size and the angle of the camera. In addition, the processor may derive a second block size of a minimum square shape including the second size, and derive a ratio occupied by a preset dangerous object and a dangerous zone in the angle based on the angle of the camera. In addition, the processor may set the first block size based on the second block size and the ratio.

Here, the processor may determine that the person is in a dangerous situation when the risk level of the first block at which the identified person is located exceeds a preset threshold risk level.

Here, the risk level of the first block may be calculated based on the preset risk object and risk zone included in the first block, the weather along the target coast, the time zone in which the person is identified, and the number of times in which the first person is identified during the preset time in the first block.

Here, the risk of the first block may be calculated using the mathematical formula below.

$$RoR = \frac{NoAPD}{NoPD} \cdot {PoRO}^{- 1} \cdot \sqrt{{FoT}^{2} + {FoW}^{2}}$$

RoR (Rate of Risk) may represent the risk level. NoAPD (Number of Average Person Discrimination) may represent the average value of the number of people identified during the first preset period in a second block in which a person is identified at least once among the plurality of blocks. NoPD (Number of Person Discrimination) may represent the number of people identified during the first preset period in the first block. PoRO (Proportion of Risk Object) may represent the ratio of the risk object and the risk zone in the first block. FoT (Factor of Time) may represent the time risk coefficient corresponding to the time zone in which the person is identified among the time risk coefficients pre-assigned from 0 to 5 by time zone. FoW (Factor of Weather) may represent the weather risk coefficient corresponding to the weather of the target coast among the weather risk coefficients pre-assigned from 0 to 5 by weather.

Here, the object detection process may extract a first human object matching the human appearance from the block. The object detection process may create a third block including the first human object, and create a virtual horizontal line based on the center of the third block to divide the upper part and the lower part. The object detection process may create a virtual vertical line based on the center of the upper part, set the leftmost point of the first human object in the upper part as the first point, and set the point where the first point and the vertical line are perpendicular to each other as the upper reference point. The object detection process may set the time point at which the first point and the upper reference point are set as the first time point, and create a first reference line connecting the first point and the upper reference point. The object detection process may create a first change line connecting the first point and the upper reference point at a second time point after a preset time interval is elapsed from the first time point, and derive a first angle between the first reference line and the first change line based on the upper reference point. The above object detection process may set the rightmost point of the first person object at the upper portion as the second point, and generate a second reference line connecting the second point and the upper reference point at the first time point. The object detection process may generate a second change line connecting the second point and the upper reference point at the second time point, derive a second angle between the second reference line and the second change line based on the upper reference point, extract the upper change amount based on the difference between the first angle and the second angle, and generate a virtual vertical line based on the center of the lower portion. The object detection process may set the leftmost point of the first person object at the lower portion as the third point, set a point where the third point and the vertical line are perpendicular to the lower reference point, and generate a third reference line connecting the third point and the lower reference point at the first time point. The above object detection process may generate a third change line connecting the third point and the lower reference point at the second time point, derive a third angle between the third reference line and the third change line based on the lower reference point, set the rightmost point of the first person object at the lower portion as a fourth point, and generate a fourth reference line connecting the fourth point and the lower reference point at the first time point. The object detection process may generate a fourth change line connecting the fourth point and the lower reference point at the second time point, derive a fourth angle between the fourth reference line and the fourth change line based on the lower reference point, and extract a lower change amount based on the difference between the third angle and the fourth angle. The object detection process may identify the first person object as a person when the upper change amount is included within a preset upper reference change amount and a preset error range, and when the lower change amount is included within a preset lower reference change amount and the error range.

In an embodiment of the present invention, an electronic device includes a memory and a processor connected to the memory. The processor receives identification information of an entering vehicle from a first camera installed at an entrance/exit of a parking lot, and confirms reservation information for a reservation time and a reserved parking space in response to the identification information. The processor confirms the location of the vehicle from a plurality of second cameras installed inside the parking lot, and generates route information based on the location of the entrance/exit of the parking lot and the reserved parking space. The processor generates guidance information based on the location of the vehicle and the route information, and provides the guidance information to a user terminal driving the vehicle.

Here, the processor may derive a vehicle image of a third camera from among the plurality of second cameras in which the vehicle is being filmed, and confirm the location of the vehicle based on the location of the third camera and the vehicle image. The processor may generate an augmented reality image corresponding to the location of the vehicle, the location of the third camera, and the angle of the third camera based on the route information. The processor may generate the guidance information by superimposing the augmented reality image on the vehicle image.

Here, the augmented reality image may be an arrow image indicating where to go on the route information based on the location of the vehicle in the vehicle image.

Here, the processor may assign a unique identification ID to each parking space in the parking lot, and derive the final parking space of the vehicle based on the vehicle image. The processor may compare the first identification ID corresponding to the final parking space with the second identification ID corresponding to the reserved parking space to confirm whether the vehicle is parked in the reserved parking space.

Here, when the final parking space of the vehicle is different from the reserved parking space, the processor may transmit to the user terminal information indicating that the final parking space is different from the reserved parking space and route information for the reserved parking space. When the final parking space is different from the reserved parking space even after a preset time has elapsed, the processor may generate a first surcharge in which preset first surcharge information is reflected in the reserved parking fee corresponding to the reservation information and transmit the first surcharge to the user terminal. When the vehicle is located in the reserved parking space exceeding the reserved time, the processor may calculate a first parking fee corresponding to the exceeded time. The processor may generate a second surcharge in which preset second surcharge information is reflected in the first parking fee and transmit the second surcharge to the user terminal.

Here, the reserved parking fee may be calculated based on the reserved time received from the user terminal, the preset basic hourly parking fee, the preset time differential index differentially set for each hour, and the preset location differential index differentially set for each reserved parking space and parking lot parking space.

Here, the above reservation parking fee may be calculated using the mathematical formula below.

$$RPF = IoPS \cdot {\sum }_{n = 1}^{k} ( SPF \times IoT\_n ) .$$

RPF (Reservation Parking Fee) may refer to the reservation parking fee, IoPS (Index of Parking Space) may refer to the location differential index of the parking space corresponding to the reservation parking space. SPF (Standard Parking Fee) may refer to the preset basic parking fee per hour, IoT (Index of Time)_n may refer to the time differential index corresponding to the nth hour among the reservation times. k may refer to the total time (Hour) included in the reservation time.

Here, the time difference index may be calculated using the mathematical formula below.

$$IoT\_n = 1.5 \cdot \frac{NoOPS}{NoTPS} - \frac{NoOPS}{NoTPS} \cdot {e}^{- ( \frac{NoE \_ n}{NoD \_ n} )}$$

NoOPS (Number of Occupied Parking Space) may refer to the average number of vehicles parked inside the parking lot at the nth time, and NoTPS (Number of Total Parking Space) may refer to the total number of parking spaces in the parking lot. NoD (Number of Departures)_n may refer to the number of vehicles departing the parking lot at the nth time, and NoE (Number of Entrances)_n may refer to the number of vehicles entering the parking lot at the nth time.

Here, the position difference index may be calculated using the mathematical formula below.

$$IoPS = \frac{NoSPS}{NoASPS} .$$

NoSPS (Number of Selection of Parking Space) may refer to the number of times that all users select to reserve a parking space corresponding to the reserved parking space during a preset period. NoASPS (Number of Average Selection of Parking Space) may refer to the average number of times that all users select to reserve all parking spaces in the parking lot during a preset period.

Here, when the identification information of the vehicle corresponds to a preset temporary parking vehicle, the processor may set a preset temporary parking space in the parking lot as the reserved parking space for the vehicle.

In an embodiment of the present invention, an electronic device includes a memory and a processor connected to the memory. The processor receives photographing data from a camera installed on a mountain, analyzes the photographing data through an artificial intelligence module to extract a gaseous cloud object, and analyzes the photographing data and the gaseous cloud object to determine whether the gaseous cloud object is caused by a fire. When the gaseous cloud object is determined to be caused by a fire, the processor derives the origin point of the gaseous cloud object and transmits the origin point and the fire determination result to an operator terminal.

Here, when the processor determines that the gaseous cloud object is caused by a fire, the processor may transmit a control command to the installed drone to photograph the origin point. In addition, the processor may transmit drone photographing data photographed by the drone to the operator terminal.

Here, the processor may divide the photographed data into a first region corresponding to a mountain and a second region corresponding to other regions, and set a narrower region based on the horizontal widths of the upper and lower portions of the gaseous cloud object in the photographed data as an origin direction criterion. When the border of the gaseous cloud object is entirely included in the first region, the processor may determine that the gaseous cloud object originated from the mountain. When the border of the gaseous cloud object touches the boundary line of the first region and the second region, and the origin direction criterion is located toward the first region, the processor may determine that the gaseous cloud object originated from the mountain. When it is determined that the gaseous cloud object originated from the mountain, the processor may determine whether the gaseous cloud object is a stain or a true gas such as smoke or fog. When it is determined that the gaseous cloud object is a true gas such as smoke or fog, the processor may receive thermal image data from the camera. The above processor may determine whether the gaseous cloud object is caused by a fire based on the thermal image data.

Here, the processor may receive information about the wind direction and wind speed from a wind meter installed on the mountain in order to determine whether the gaseous cloud object is a stain or a true gas such as smoke or fog, and derive a first object center where a first maximum horizontal width and a first maximum vertical width of the gaseous cloud object intersect at a first point in time. The processor may derive a second object center where a second maximum horizontal width and a second maximum vertical width of the gaseous cloud object intersect at a second point in time when a preset time has elapsed from the first point in time. The processor may compare a preset first center movement distance on the angle of the camera based on the wind speed with a second center movement distance between the first object center and the second object center on the angle of the camera. The processor may compare the wind direction with the direction of the second center displacement distance, and when the direction of the second center displacement distance is within a first error range set with the wind direction and the second center displacement distance is within a second error range set with the first center displacement distance, the processor may determine that the gaseous cloud object is a true gas such as smoke or fog.

When the direction of the second center displacement distance is within the first error range with the wind direction but the second center displacement distance is outside the second error range with the first center displacement distance, the processor may select one of the longest horizontal width or the longest vertical width that is closer to the wind direction. The processor may derive a gas diffusion change rate corresponding to a ratio of the second longest horizontal width or the second longest vertical width to the selected first longest horizontal width or the first longest vertical width. When the above gas diffusion change rate is within a preset third error range and a preset reference diffusion change rate corresponding to the diffusion rate of smoke or fog based on the wind speed, the processor may determine that the gas cloud object is a true gas such as smoke or fog.

Here, the processor, in order to determine whether the gaseous cloud object is caused by a fire, may generate a first block from the photographed data, which includes the gaseous cloud object and has a maximum horizontal width and a maximum vertical width of the gaseous cloud object as the horizontal length and the vertical length, respectively. The processor may divide the first area into a plurality of second blocks having the same size as the first block, divide the second area into a plurality of third blocks having the same size as the first block, and derive a first maximum temperature from the first block based on the thermal image data. The processor may derive a second maximum temperature for each of the second blocks based on the thermal image data, calculate a first average value corresponding to an average value of the second maximum temperatures, and derive a third maximum temperature for each of the third blocks based on the thermal image data, and calculate a second average value corresponding to an average value of the third maximum temperatures. When the first maximum temperature exceeds the preset first threshold temperature, the processor may determine that the gaseous cloud object is caused by a fire, and compare the first maximum temperature with the first average value. When the difference between the first maximum temperature and the first average value is within the preset fourth error range, the processor may determine that there is a high possibility of a large-scale forest fire. Here, the processor may transmit information indicating that a fire has occurred to a preset related organization or control center and the operator terminal. When the difference between the first maximum temperature and the first average value is outside the fourth error range, the processor may determine that the fire is a localized fire, and transmits a control command to have the drone photograph the origin point. Here, the processor may transmit drone photographing data photographed by the drone to the operator terminal. When the first maximum temperature is lower than or equal to the first threshold temperature and exceeds a preset second threshold temperature that is lower than the first threshold temperature, the processor may compare the first maximum temperature with the first average value and the second average value. When the difference between the first maximum temperature and the first average and the second average is within the fourth error range, the processor may determine that the temperature rise is due to the weather and transmits the determination result to the operator terminal. When the first maximum temperature and the first average are within the fourth error range and the first maximum temperature and the second average are outside the fourth error range, the processor may determine that there is a high possibility of fire. Here, the processor may transmit a control command to the drone to photograph the origin point and transmit drone photographing data photographed by the drone to the operator terminal.

In an embodiment of the present invention, a traffic accident analysis system includes: a dataset construction unit for constructing each standard traffic accident data set from a plurality of standard traffic accident information; an omniscient expression unit for mapping image data of actual traffic accident information photographed on a road onto a two-dimensional plane map; and a traffic accident estimation unit for comparing the actual traffic accident information mapped by the omniscient expression unit with each standard traffic accident data set constructed by the dataset construction unit to estimate standard traffic accident information similar to the actual traffic accident information.

The dataset construction unit may classify the type of traffic accident from each standard traffic accident information and perform labeling according to the type of classified traffic accident to construct each of the above standard traffic accident datasets.

The types of traffic accidents may include vehicle-to-vehicle, vehicle-to-person, vehicle-to-motorcycle, and vehicle-to-bicycle.

The dataset constructed in the above dataset construction unit may be a dataset constructed including not only image data of standard traffic accident information but also text data which is explanatory material describing the traffic accident.

The omniscient expression unit may identify the boundary of an object from the actual traffic accident image and display a bounding box to identify the direction and angle of the object.

The omniscient expression unit may display circular distance lines at predetermined distance intervals on the actual traffic accident image, and perform mapping on the two-dimensional flat map by considering distance and angle using the displayed circular distance lines.

The actual traffic accident information may include information on traffic signals at the time of the traffic accident video.

The traffic accident estimation unit may include a unit that extracts image features in a manner that effectively recognizes and emphasizes features from adjacent images while maintaining spatial information of the image, and a unit that classifies the image.

The traffic accident analysis system may include a video surveillance device and a management server, the video surveillance device may comprise the omniscient expression unit and the traffic accident estimation unit, and the management server may comprise the dataset construction unit.

The traffic accident estimation unit of the above video surveillance device may provide the user terminal with standard traffic accident information and similarity information of similar circumstances to actual traffic accident information.

In another embodiment of the present invention, a traffic accident analysis method in a traffic accident analysis system includes: a constructing each standard traffic accident data set from a plurality of standard traffic accident information; a mapping image data of actual traffic accident information photographed on a road onto a two-dimensional plane map; and a comparing the actual traffic accident information mapped in the mapping step with each standard traffic accident data set constructed in the constructing step to estimate standard traffic accident information similar to the actual traffic accident information.

In an embodiment of the present invention, an electronic device for performing a situation determination operation based on information of an object includes a memory; a processor; and a camera. The processor directly processes an artificial intelligence model based on image processing, identifies information of the object by using an image of the object captured by the camera as an input of the artificial intelligence model based on image processing, and performs the situation determination operation based on information of the identified object.

In an embodiment of the present invention, an electronic device for performing a situation determination operation based on information of an object includes a memory; a processor; and a camera. The processor independently processes an artificial intelligence model based on image processing, identifies information of the object by using an image of the object captured by the camera as an input of the artificial intelligence model based on image processing, and performs the situation determination operation based on the information of the identified object.

In an embodiment of the present invention, an electronic device for performing a situation determination operation based on information of an object includes a memory; a processor; and a camera. The electronic device is not a central control device on a network but a device installed locally to implement artificial intelligence-based control and/or processing. The processor processes an artificial intelligence model based on image processing, identifies information about the object by using an image of the object captured by the camera as an input to the artificial intelligence model, and performs the situation determination operation based on the information about the identified object.

In an embodiment, the processor may receive identification information and location information of a vehicle from the camera, and check reservation information of the vehicle in response to the received identification information to generate route information and/or guidance information of the vehicle.

In an embodiment of the present invention, an electronic system for performing a situation determination operation based on information of an object includes a first electronic device, a second electronic device, and a third electronic device, which include a processor for receiving identification information and location information of a vehicle from the camera, and confirming reservation information of the vehicle in response to the received identification information to generate route information and/or guidance information of the vehicle. The processor of the first electronic device receives information of the vehicle from a camera of the first electronic device, the processor of the second electronic device confirms the location of the vehicle from a camera of the second electronic device and a camera of the third electronic device, the camera of the third electronic device derives an image in which the vehicle is captured, and the processor of the third electronic device derives a final parking space of the vehicle based on the derived image.

In an embodiment, the situation determination operation may construct a dataset through comparison and evaluation with a plurality of real data by the processor, learn using the constructed dataset, and estimate the similarity with the image of the object captured by the camera.

In an embodiment, the processor may estimate similarity with the image of the object captured by the camera by applying a convolutional neural network.

In an embodiment, the processor may divide the image of the object captured by the camera into a plurality of blocks and perform an object detection process on the plurality of blocks.

In an embodiment, the processor may control the camera to operate as a thermal imaging camera.

In an embodiment, the processor may identify a person through the object detection process and transmit information indicating that the identified person is in a dangerous situation to the user terminal when a risk level of the block in which the identified person is located exceeds a preset threshold risk level.

In an embodiment, the processor may analyze an image of the object captured by the camera to extract a gaseous cloud object and receive thermal image data from the camera when the processor is determined that the gaseous cloud object is a true gas.

In an embodiment, the processor may construct a dataset from standard traffic accident information, map an image of the object of actual traffic accident information captured by the camera onto a two-dimensional flat map, compare the dataset with the actual traffic accident information, and estimate the standard traffic accident information similar to the actual traffic accident information.

### Advantageous Effects

According to the embodiment of the present invention, the device providing the object identification and advance warning based on the edge AI technology may be provided.

According to the embodiment of the present invention, the device and method for providing the artificial intelligence-based vehicle parking reservation and guidance service may be provided.

According to the embodiment of the present invention, the edge artificial intelligence-based forest fire precision detection and response device and method may be provided.

By the above-described configuration, the present invention may objectively determine whether there is negligence and the negligence ratio by analyzing actual traffic accident information and estimating the similarity based on standard traffic accident information.

The present invention also enables analysis of traffic accidents in the two-dimensional plane by mapping image data of actual traffic accident information onto the two-dimensional flat map, thereby enabling more accurate estimation of the type of traffic accident.

The present invention also enables safety diagnosis and prevention of traffic safety solutions by constructing the dataset according to the type of traffic accident as basic data for prevention, diagnosis, response, and prediction of traffic accidents.

### DESCRIPTION OF DRAWINGS

FIG. 1 is a conceptual view of a coastal human identification and disaster advance warning device according to an embodiment of the present invention.

FIG. 2 is a block diagram of an electronic device according to an embodiment of the present invention.

FIG. 3 is an exemplary view of dividing a photographed image according to an embodiment of the present invention.

FIG. 4 is an exemplary view of generating a first block size according to an embodiment of the present invention.

FIG. 5 is an exemplary table of weather risk factors and time risk factors according to an embodiment of the present invention.

FIG. 6 is an exemplary view for identifying a person according to an embodiment of the present invention.

FIG. 7 is a conceptual view of another embodiment of an object detection process of the present invention.

FIG. 8 is a conceptual view of another embodiment of an object detection process of the present invention.

FIG. 9 is a flow chart of a coastal person identification and disaster advance warning method according to an embodiment of the present invention.

FIG. 10 is a conceptual view of an artificial intelligence-based vehicle parking reservation and guidance service providing device according to an embodiment of the present invention.

FIG. 11 is a block view of an electronic device according to an embodiment of the present invention.

FIG. 12 is a view illustrating generation of route information according to an embodiment of the present invention.

FIG. 13 is a view illustrating confirmation of a location of a vehicle according to an embodiment of the present invention.

FIG. 14 is a view illustrating guidance information in which an augmented reality image is superimposed on a vehicle image according to an embodiment of the present invention.

FIG. 15 is a flowchart of a method for providing an artificial intelligence-based vehicle parking reservation and guidance service according to an embodiment of the present invention.

FIG. 16 is a conceptual view of an edge artificial intelligence-based forest fire precision detection and response device according to an embodiment of the present invention.

FIG. 17 is a block diagram of an electronic device according to an embodiment of the present invention.

FIG. 18 is an exemplary view of a photographed image according to an embodiment of the present invention.

FIG. 19 is an exemplary view for determining the origin of a gaseous cloud object according to an embodiment of the present invention.

FIGS. 20 and 21 are exemplary views for determining whether a gaseous cloud object is a real gas according to an embodiment of the present invention.

FIG. 22 is an exemplary view for determining whether a gaseous cloud object is caused by a fire according to an embodiment of the present invention.

FIG. 23 is a flowchart of a method for precise detection and response to a forest fire based on edge artificial intelligence according to an embodiment of the present invention.

FIG. 24 is a schematic view illustrating a traffic accident analysis system according to an embodiment of the present invention.

FIG. 25 is a block diagram illustrating a case where the video surveillance device or

management server illustrated in FIG. 24 operates as a general electronic device.

FIG. 26 is a block diagram of a traffic accident analysis system according to another embodiment of the present invention.

FIG. 27 is an exemplary view of two-dimensional images by type and/or situation of a standard traffic accident according to an embodiment of the present invention.

FIGS. 28 and 29 are views illustrating examples of matching camera images to Naver maps according to an embodiment of the present invention.

FIG. 30 is an exemplary view of estimating a standard traffic accident type of an actual traffic accident situation according to an embodiment of the present invention.

FIG. 31 is an exemplary view of displaying a standard traffic accident estimation result of an actual traffic accident situation according to an embodiment of the present invention.

FIG. 32 is a flowchart of a traffic accident analysis method according to another embodiment of the present invention.

### MODE FOR INVENTION

Hereinafter, embodiments of the present invention will be described in detail with reference to the attached drawings.

In describing the embodiments, descriptions of technical contents that are well known in the technical field to which the present invention belongs and are not directly related to the present invention will be omitted. This is to convey the gist of the present invention more clearly without obscuring it by omitting unnecessary descriptions.

For the same reason, some components in the attached drawings are exaggerated, omitted, or schematically illustrated. In addition, the size of each component does not entirely reflect the actual size. The same or corresponding components in each drawing are given the same reference numbers.

The advantages and features of the present invention, and the methods for achieving them, will become clear with reference to the embodiments described in detail below together with the accompanying drawings. However, the present invention is not limited to the embodiments disclosed below, but may be implemented in various different forms.

These embodiments are provided only to make the disclosure of the present invention complete and to fully inform those skilled in the art of the scope of the invention, and the present invention is defined only by the scope of the claims. Like reference numerals refer to like elements throughout the specification.

Here, it will be understood that each block of the processing flow diagram and the combination of the flow diagrams may be performed by computer program instructions. These computer program instructions may be loaded onto a processor of a general-purpose computer, a special-purpose computer, or other programmable data processing equipment, so that the instructions executed by the processor of the computer or other programmable data processing equipment create a means for performing the functions described in the flow diagram block(s). These computer program instructions may also be stored in a computer-available or computer-readable memory that may be directed to a computer or other programmable data processing equipment to implement the functions in a specific manner. The instructions stored in the computer-available or computer-readable memory may also produce a manufactured article including an instruction means for performing the functions described in the flow diagram block(s). The computer program instructions may also be loaded onto a computer or other programmable data processing equipment. A series of operational steps are performed on the computer or other programmable data processing equipment. Instructions that create a computer-executable process that performs the operations of a computer or other programmable data processing device may also provide steps for performing the functions described in the flowchart block(s).

Also, each block may represent a module, segment, or portion of code that contains one or more executable instructions for performing a specified logical function(s). It should be noted that in some alternative implementation examples, the functions mentioned in the blocks may occur out of order. For example, two blocks shown in succession may in fact be performed substantially concurrently, or the blocks may sometimes be performed in reverse order, depending on the functionality they perform.

Here, the term ‘˜part’ used in the present embodiment means software or hardware components such as FPGA (field-programmable gate array) or ASIC (application specific integrated circuit), and the ‘˜part’ performs certain roles. However, the ‘˜part’ is not limited to software or hardware. The ‘˜part’ may be configured to be in an addressable storage medium and may be configured to reproduce one or more processors. Accordingly, as an example, the ‘˜part’ includes components such as software components, object-oriented software components, class components, and task components, and processes, functions, properties, procedures, subroutines, segments of program code, drivers, firmware, microcode, circuits, data, databases, data structures, tables, arrays, and variables. The functions provided in the components and ‘˜parts’ may be combined into a smaller number of components and ‘˜parts’ or further separated into additional components and ‘˜parts’. Also, the components and ‘˜parts’ may be implemented to regenerate one or more CPUs within the device or secure multimedia card.

In describing the embodiments of the present invention in detail, examples of specific systems will be mainly used. However, the main idea claimed in this specification may be applied to other communication systems and services with similar technical backgrounds, within a scope that does not significantly exceed the scope disclosed in this specification. This may be done at the discretion of a person skilled in the relevant technical field.

Device that Provides Object Identification and Advance Warning Based on Edge AI Technology

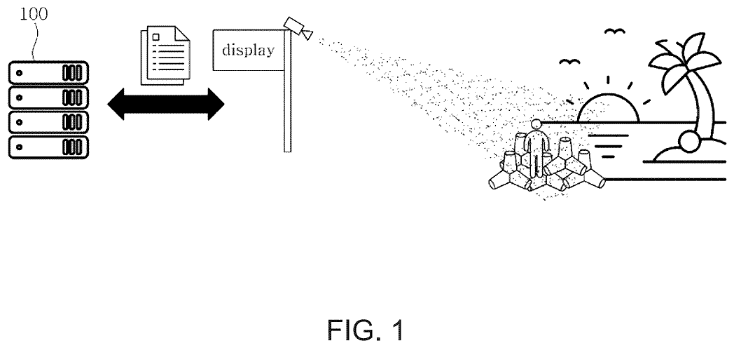

FIG. 1 is a conceptual view of a coastal human identification and disaster advance warning device 100 according to an embodiment of the present invention.

Referring to FIG. 1, a coastal human identification and disaster advance warning device 100 according to an embodiment of the present invention may perform a situation determination operation based on information of an object. In addition, the coastal human identification and disaster advance warning device 100 is not a central control device on a network, and may be installed locally to implement artificial intelligence-based control and/or processing. Specifically, the coastal human identification and disaster advance warning device 100 identifies a person on the coast with a camera and determines whether the person is in a dangerous situation. The coastal human identification and disaster advance warning device 100 may provide a warning about a dangerous situation to an adjacent display and an operator terminal of an operator operating the electronic device 100 based on the determination result.

Meanwhile, the coastal human identification and disaster advance warning device 100 may also be referred to as an ‘electronic device 100’ in the present invention.

Here, the operator terminal may include a communication-capable desktop computer, a laptop computer, a notebook, a smart phone, a tablet PC, a mobile phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital video recorder, a digital video player, and a personal digital assistant (PDA).

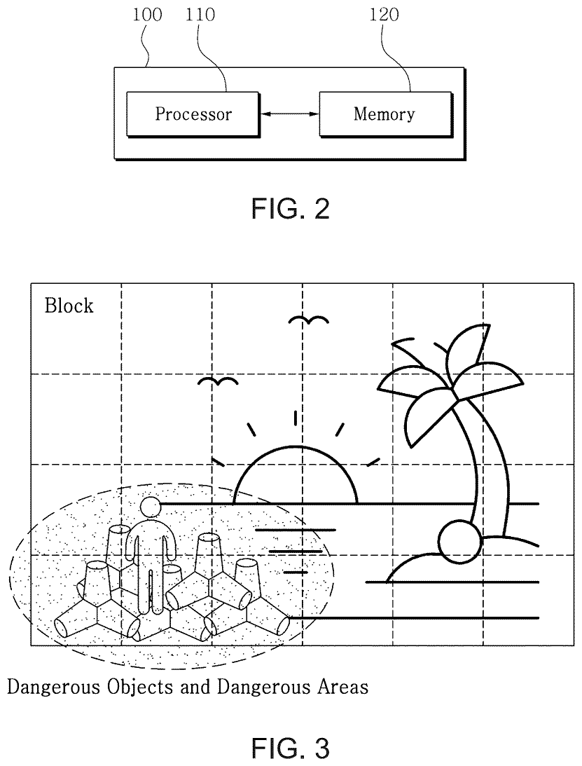

FIG. 2 is a block diagram of an electronic device 100 according to an embodiment of the present invention.

The electronic device 100 according to an embodiment includes a processor 110 and a memory 120. In addition, the electronic device 100 may include a processor 110, a memory 120, and a camera. The processor 110 may perform at least one of the methods described above. The memory 120 may store information related to the method described above or may store a program in which the method described above is implemented. The memory 120 may be a volatile memory or a nonvolatile memory. The memory 120 may be referred to as a ‘database’, a ‘storage’, or the like.

The processor 110 may execute a program and control the electronic device 100. A code of the program executed by the processor 110 may be stored in the memory 120. The electronic device 100 may be connected to an external device (e.g., a personal computer or a network) through an input/output device (not shown) and exchange data.

Here, the processor 110 may receive a photographed image from a camera installed on the target coast.

Here, the camera may include both a general visible light camera and a thermal imaging camera or perform both functions together. That is, the processor 110 may control the camera to operate as a thermal imaging camera.

Here, the processor 110 controls the camera to operate as a thermal imaging camera based on weather information when visibility is poor due to fog or other conditions, or at night. Accordingly, the processor 110 may identify a person even in a situation in which visibility (visible light) is poor.

In addition, the processor 110 may directly process an artificial intelligence model based on image processing, and may independently process an artificial intelligence model based on image processing. The processor 110 may identify information about an object by using an image of an object captured by a camera as input to an artificial intelligence model based on image processing. Specifically, the processor 110 may identify a person in the captured image through an artificial intelligence module, and determine whether the person is in a dangerous situation based on a risk level based on the location and time at which the person is identified.

Here, the artificial intelligence module may learn human images and identify people in captured images using deep learning that is a kind of machine learning.

Also, the AI module may learn weights of multiple inputs in the above function through deep learning. Also, various AI network models such as RNN (Recurrent Neural Network), DNN (Deep Neural Network), and DRNN (Dynamic Recurrent Neural Network) may be used for such learning.

Here, RNN is a deep learning technique that considers current data and past data simultaneously, and a recurrent neural network (RNN) is a neural network in which the connections between the units constituting the artificial neural network form a directed cycle. Furthermore, various methods may be used for the structure that may configure a recurrent neural network (RNN). For example, a fully recurrent network, a Hopfield network, an Elman network, an Echo state network (ESN), a Long short term memory network (LSTM), a Bi-directional RNN, a Continuous-time RNN (CTRNN), a Hierarchical RNN, and a Second-order RNN are representative examples. In addition, methods such as gradient descent, Hessian Free Optimization, and Global Optimization Method may be used to train a recurrent neural network (RNN).

However, the above artificial intelligence module has a problem in that the artificial intelligence may be difficult to distinguish an actual moving person from a human-shaped object (e.g., a signboard, etc.). Accordingly, the present invention proposes a configuration that identifies a person through movement. This will be described later.

Also, the processor 110 may perform a situation determination operation based on information about the identified object. Specifically, when the processor 110 determines that a person is in a dangerous situation, the processor 110 may visually display the location of the person on the camera image on the installed display and output it.

Here, the display may output guidance information provided to a target area in normal times. For example, geographical guidance and weather information may be output.

Also, the processor 110 may perform a situation determination operation based on information of an identified object. Specifically, the processor 110 may transmit information indicating that a person is in a dangerous situation to an operator terminal used by an operator operating an electronic device 100.

Through this, people in dangerous situations may be rescued or guided out of the area.

FIG. 3 is an exemplary view for dividing a photographed image according to an embodiment of the present invention.

In order to accurately identify a person using an artificial intelligence module, the captured image needs to be divided into certain parts and analyzed intensively.

For this, the processor 110 may divide the image of an object captured by the camera into a plurality of blocks and perform an object detection process on the plurality of blocks. Specifically, the processor 110 may divide the captured image into a plurality of blocks each having a preset first block size and sequentially perform an object detection process on the plurality of blocks through an artificial intelligence module, thereby identifying the person. Here, the object detection process will be described later.

In addition, as described later, the block size may be determined based on the proportion of the dangerous object (tetrapod) or dangerous zone (tidal flat) in the photographed image. This will be described later.

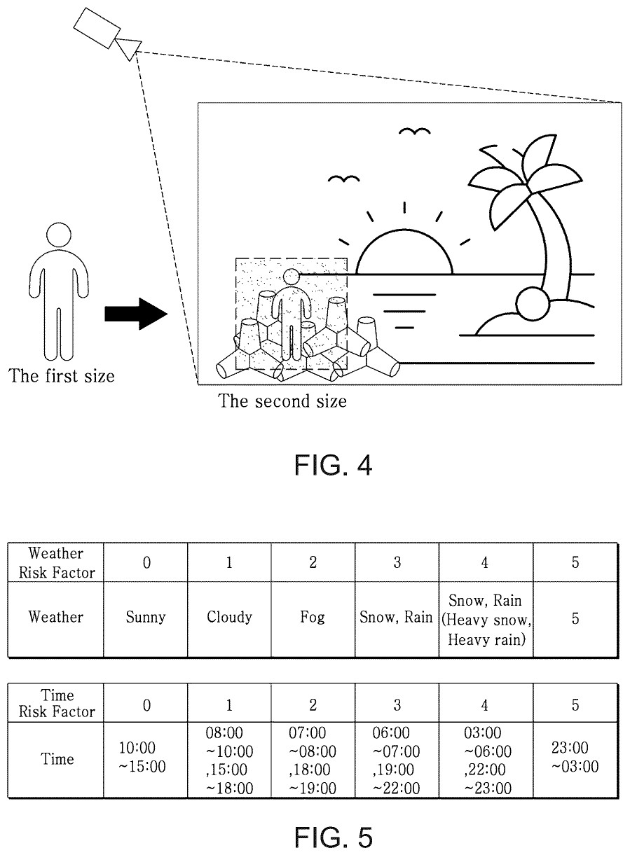

FIG. 4 is an exemplary view of generating a first block size according to an embodiment of the present invention.

The proportion of dangerous objects or dangerous zones in the above-mentioned captured image is too large. When the block size is determined only by the size of the object to be identified, there is a risk that the search will be conducted in unimportant areas, resulting in a waste of resources.

For this, it is necessary to appropriately adjust the first block size.

For this, the processor 110 receives a first size of an object to be identified, and derives a second size in the case where the object exists in the photographed image based on the first size and the angle of the camera. The processor 110 derives a second block size of a minimum square shape including the second size, derives a ratio occupied by a preset dangerous object and a dangerous zone in the angle based on the angle of the camera, and sets the first block size based on the second block size and the ratio.

Here, the first block size may be set to a value obtained by multiplying the second block size by the reciprocal of the ratio.

Also, the processor 110 identifies a person through an object detection process,

When the risk level of the block in which the identified person is located exceeds a preset threshold risk level, information indicating that the identified person is in a dangerous situation may be transmitted to the user terminal 200. Specifically, when the risk level of the first block in which the identified person is located exceeds a preset threshold risk level, the processor 110 may determine that the person is in a dangerous situation.

Here, the risk level of the first block may be calculated based on the preset risk object and risk zone included in the first block, the weather along the target coast, the time zone in which the person is identified, and the number of times the first person is identified during the preset time in the first block.

More specifically, the risk of the first block may be calculated by the mathematical formula 1 below.

$$RoR = \frac{NoAPD}{NoPD} \cdot {PoRO}^{- 1} \cdot \sqrt{{FoT}^{2} + {FoW}^{2}} \qquad [ Mathematical formula 1 ]$$

Here, RoR (Rate of Risk) may refer to the risk level, NoAPD (Number of Average Person Discrimination) may refer to the average value of the number of people identified during the first preset period in the second block in which a person is identified at least once among the plurality of blocks. NoPD (Number of Person Discrimination) may refer to the number of people identified during the first preset period in the first block. PoRO (Proportion of Risk Object) may refer to the ratio occupied by the risk object and the risk zone in the first block. FoT (Factor of Time) may refer to the time risk coefficient corresponding to the time zone in which the person is identified among the time risk coefficients pre-assigned from 0 to 5 by time zone. FoW (Factor of Weather) may refer to the weather risk coefficient corresponding to the weather of the target coast among the weather risk coefficients pre-assigned from 0 to 5 by weather.

Here, the weather risk coefficient and the time risk coefficient may be arbitrarily set by the operator as shown in FIG. 5.

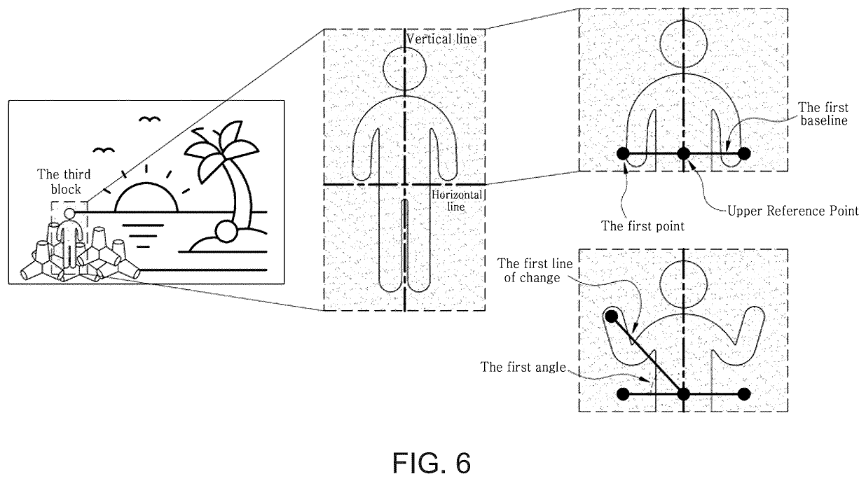

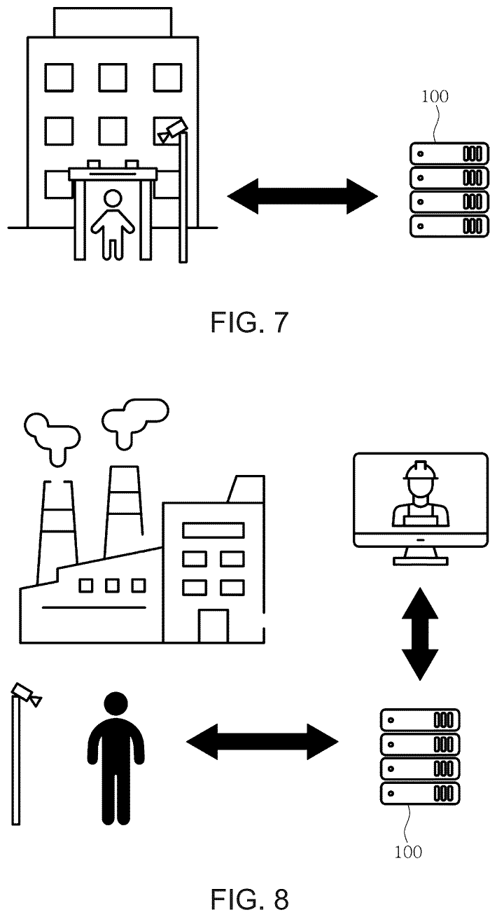

FIG. 6 is an exemplary view for identifying a person according to an embodiment of the present invention.

As mentioned above, there is a risk of false alarms when a simple object with a human shape is identified, so it is necessary to check based on movement to confirm whether it is a real person.

For this, as described above, the processor 110 identifies a person through the object detection process. The object detection process extracts a first person object matching the appearance of a person from the block, and creates a third block including the first person object. The object detection process creates a virtual horizontal line based on the center of the third block to divide the upper part and the lower part, and creates a virtual vertical line based on the center of the upper part. The object detection process sets the leftmost point of the first person object in the upper part as the first point, sets the point at which the first point and the vertical line are perpendicular as the upper reference point, and sets the time point at which the first point and the upper reference point are set as the first time point. The above object detection process generates a first reference line connecting the first point and the upper reference point, generates a first change line connecting the first point and the upper reference point at a second time point when a preset time interval has elapsed from the first time point, and derives a first angle between the first reference line and the first change line based on the upper reference point. The object detection process sets the rightmost point of the first human object at the upper portion as the second point, generates a second reference line connecting the second point and the upper reference point at the first time point, generates a second change line connecting the second point and the upper reference point at the second time point, and derives a second angle between the second reference line and the second change line based on the upper reference point. The above object detection process extracts the upper variation amount based on the difference between the first angle and the second angle, generates a virtual vertical line based on the center of the lower portion, sets the leftmost point of the first person object at the lower portion as a third point, sets a point at which the third point and the vertical line are perpendicular to a lower reference point, and generates a third variation line connecting the third point and the lower reference point at the first time point. The object detection process generates a third variation line connecting the third point and the lower reference point at the second time point, derives a third angle between the third variation line and the third variation line based on the lower reference point, sets the rightmost point of the first person object at the lower portion as a fourth point, generates a fourth variation line connecting the fourth point and the lower reference point at the first time point, and generates a fourth variation line connecting the fourth point and the lower reference point at the second time point. The above object detection process derives a fourth angle between the fourth reference line and the fourth change line based on the lower reference point, and extracts a lower change amount based on the difference between the third angle and the fourth angle. When the upper change amount is included within the preset upper reference change amount and the preset error range, and when the lower change amount is included within the preset lower reference change amount and the error range, the first human object may be identified as a person.

Here, the upper reference change amount and the above-mentioned lower reference change amount may be set as the average value of the upper reference change amount and the lower reference change amount when a person moves.

Also, the error range may be arbitrarily set by the operator and may be set to 10%, for example.

This is not about determining a person based on simple movements, but is based on the idea that when a person moves or acts, the left and right move in a mutually related manner. When a real person moves, it may be identified as a person, which may improve accuracy.

The object detection process described above may also be applied to a technology for identifying people inside a building and determining a position of the people when fire occurs. The object detection process described above may also be applied to a technology for determining whether people are wearing safety equipment in an industrial area.

More specifically, referring to FIG. 7, in an artificial intelligence-based building fire safety solution system, an electronic device may include a memory and a processor connected to the memory. The processor may receive a photographed image from a camera installed at an entrance or exit of a building, identify a person in the photographed image, counts the number of people entering or exiting the building, and check the number of people remaining in the building in the event of an emergency such as a fire.

Here, as a configuration for identifying a person in the above-described photographed image, a person may be identified through the object identification process described above.

Also, through the artificial intelligence module, a facial area of the identified person may be analyzed separately to enable identity verification.

Here, the DB for identity verification may continuously update information on new and old employees in order to accurately determine whether or not the employees are allowed to enter the building.

Also, in order for this system to operate smoothly even when fire occurs, it is desirable that cables connecting the system and the camera or antennas for wireless connection are made of flame retardant cables and materials.

Also, since power supply may not be smooth in emergency situations such as fire, this system may be configured to operate as an independent power source, including an uninterruptible power supply system (UPS).

In another embodiment, referring to FIG. 8, an AI-based industrial safety management system includes an electronic device having a memory and a processor connected to the memory. The processor may receive a photographed image from a camera installed in an industrial complex and identify a person in the photographed image through an AI module. Based on the angle of the camera, the risk level of the industrial complex where the camera is installed is calculated through the ratio of a dangerous object and a dangerous zone. When a person is identified in a place with a high risk level, a warning message may be provided to an operator (manager, manager, etc.).

Here, as a configuration for identifying a person in the above-described photographed image, a person may be identified through the object detection process described above.

Also, by analyzing the clothing of a person identified through an artificial intelligence module, it is possible to check whether the person is wearing clothing or equipment (X-band, high bar, goggles) that must be worn within the industrial complex where the camera is installed. When the clothing is not properly worn, a warning message may be provided to the operator.

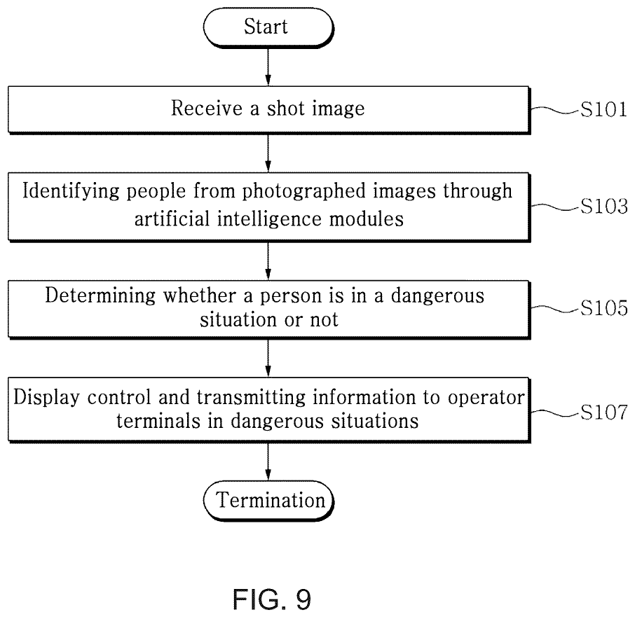

FIG. 9 is a flow chart of a coastal human identification and disaster advance warning method according to an embodiment of the present invention.

Referring to FIG. 9, a coastal person identification and disaster advance warning method according to an embodiment of the present invention may receive a photographed image from a camera installed along the target coast in operation S101.

Also, the coastal person identification and disaster advance warning method according to an embodiment of the present invention may identify a person in the photographed image through an artificial intelligence module in operation S103.

Also, the coastal person identification and disaster advance warning method according to an embodiment of the present invention may determine whether the person is in a dangerous situation based on a risk level based on the location and time at which the person is identified in operation S105.

Also, according to an embodiment of the present invention, the coastal person identification and disaster advance warning method may visually display the location of the person on an image captured by the camera on a pre-installed display when the person is judged to be in a dangerous situation and transmit information indicating that the person is in a dangerous situation to an operator terminal used by an operator operating the electronic device 100 in operation S107.

Also, the coastal person identification and disaster advance warning method according to an embodiment of the present invention may be configured identically to the coastal person identification and disaster advance warning device 100 disclosed in FIGS. 1 to 8

### Device and Method for Providing Edge AI-Based Vehicle Parking Reservation and Guidance Service

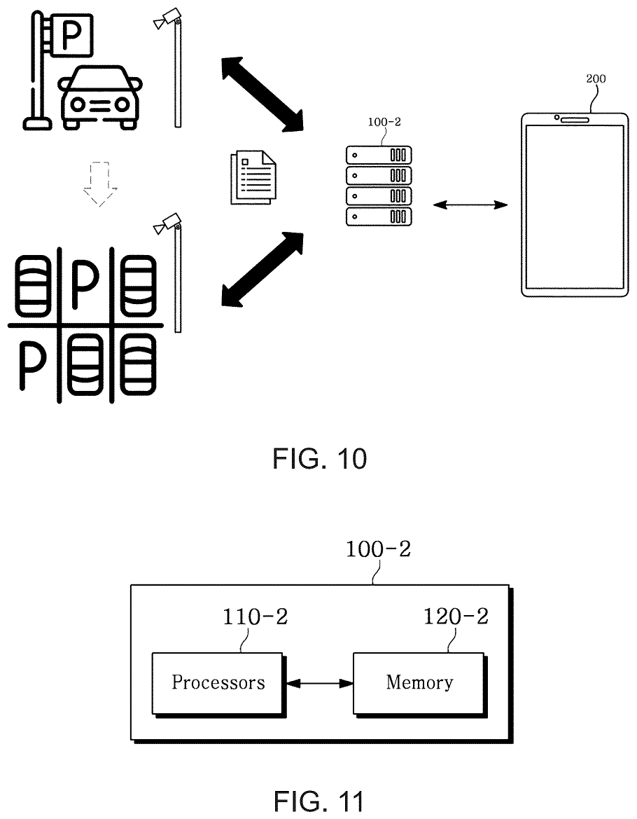

FIG. 10 is a conceptual view of an artificial intelligence-based vehicle parking reservation and guidance service providing device according to an embodiment of the present invention.

Referring to FIG. 10, an AI-based vehicle parking reservation and guidance service providing device 100-2 according to an embodiment of the present invention may perform a situation determination operation based on information of an object. In addition, the AI-based vehicle parking reservation and guidance service providing device 100-2 is not a central control device on a network, but a device installed locally to implement AI-based control and/or processing. Specifically, the AI-based vehicle parking reservation and guidance service providing device 100-2 guides a user terminal 200 so that a vehicle of a user who has reserved a parking space and time may park in the reserved parking space. Accordingly, the AI-based vehicle parking reservation and guidance service providing device 100-2 may reduce the vehicle's travel time, prevent environmental pollution by reducing exhaust gas emissions, and prevent illegal parking.

Meanwhile, the AI-based vehicle parking reservation and guidance service providing device may be referred to as an ‘electronic device 100-2’ in the present invention. In addition, as an AI-based device, it may be installed in various places in the parking lot (e.g., ceiling, pillar, wall, etc.) rather than a central control device, so that each device may implement AI-based control and/or processing. Therefore, it may also be referred to as an ‘edge AI device’.

FIG. 11 is a block diagram of an electronic device 100-2 according to an embodiment of the present invention.

The electronic device 100-2 according to an embodiment includes a processor 110-2 and a memory 120-2. In addition, the electronic device 100-2 may include a processor 110-2, a memory 120-2, and a camera.

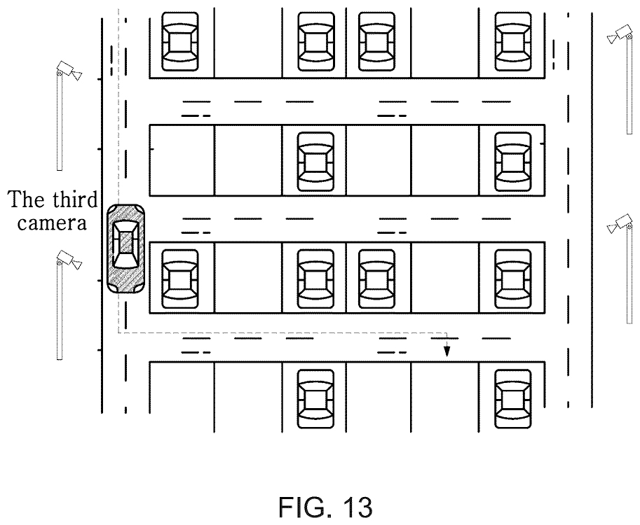

In addition, the electronic device 100-2 may include a server, an external device, etc. that control cameras (e.g., first to the third cameras) to be described with reference to FIGS. 10, 12 to 15. Each of the first camera to the third camera may be implemented as the electronic device 100-2. For example, each of the first camera to the third camera may include a processor 110-2 and a memory 120-2. The processor 110-2 may receive identification information of the vehicle and location information of the vehicle from the camera, and may check reservation information of the vehicle in response to the received identification information to generate route information and/or guidance information of the vehicle. Specifically, the processor 110-2 may implement a function for providing an edge AI-based vehicle parking reservation and guidance service. In this case, each of the first camera to the third camera may perform a function as an edge AI device. The processor 110-2 may perform at least one of the methods described above. The memory 120-2 may store information related to the above-described method or store a program in which the above-described method is implemented. The memory 120-2 may be a volatile memory or a non-volatile memory. The memory 120-2 may be called a ‘database’, a ‘storage unit’, etc.

The processor 110-2 may execute a program and control the electronic device 100-2. The code of the program executed by the processor 110-2 may be stored in the memory 120-2. The electronic device 100-2 may be connected to an external device (e.g., a personal computer or a network) through an input/output device (not shown) and exchange data. The processor 110-2 may directly process an image processing-based artificial intelligence model and independently process an image processing-based artificial intelligence model. The processor 110-2 may identify information about an object by using an image of an object captured by a camera as an input of an image processing-based artificial intelligence model. Here, the processor 110-2 of the first electronic device may receive information about the vehicle from the camera of the first electronic device. That is, the processor 110-2 of the first electronic device may receive identification information about an entering vehicle from a first camera installed at the entrance/exit of a parking lot.

When a vehicle is photographed by the first camera, the vehicle's license plate may be recognized to identify the vehicle, and the identification information may represent the vehicle's license plate number.

Also, the processor 110-2 may check reservation information for the reservation time and reserved parking space in response to the above identification information.

A user of a vehicle corresponding to the above identification information may reserve in advance from what time to what time he or she will park and in which parking space he or she will park. The processor 110-2 confirms the information about this.

Also, the processor 110-2 of the second electronic device may confirm the location of the vehicle from a plurality of second cameras installed inside the parking lot.

The second camera also may recognize the vehicle and the license plate number of the vehicle in the captured video and determine the location of the vehicle based on the location of the second camera and the angle of the vehicle.

Here, an artificial intelligence module may be used to identify the license plate number of the vehicle and the location of the vehicle accordingly.

Here, the artificial intelligence module may create a machine learning model trained to collect information about the location of a vehicle's license plate and license number, using the deep learning technique, which is a field of machine learning.

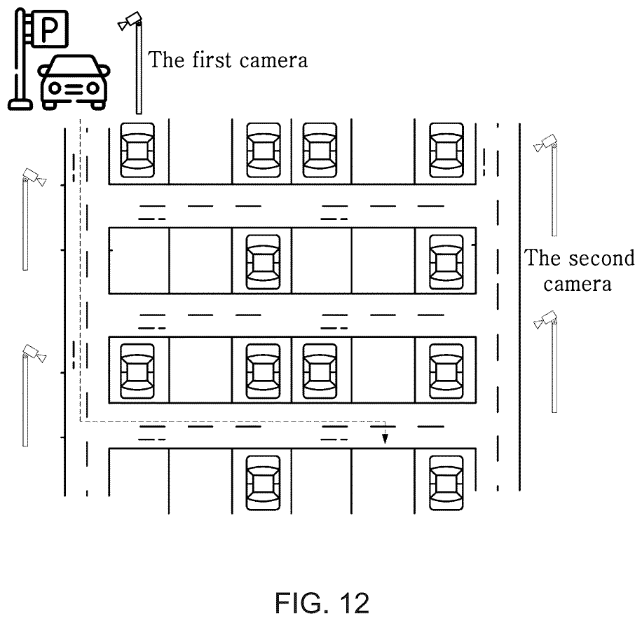

Also, the processor 110-2 may generate route information based on the location of the entrance and exit of the parking lot and the reserved parking space. The generation of route information will be described in more detail with reference to FIGS. 12 to 14.

Also, the processor 110-2 may generate guidance information based on the location of the vehicle and the route information, and provide the guidance information to a user terminal driving the vehicle.

FIG. 11 is a view illustrating generation of route information according to an embodiment of the present invention. FIG. 12 is a view illustrating confirmation of the location of a vehicle according to an embodiment of the present invention.

Referring to FIGS. 11 and 12, the processor 110-2 of the third electronic device may derive an image in which a vehicle is being filmed, and derive a final parking space of the vehicle based on the derived image. Specifically, the processor 110-2 of the third electronic device derives a vehicle image of a third camera among a plurality of second cameras in which the vehicle is being filmed. The processor 110-2 of the third electronic device confirms the location of the vehicle based on the location of the third camera and the vehicle image, and generates an augmented reality image corresponding to the location of the vehicle, the location of the third camera, and the angle of the third camera based on the route information. The processor 110-2 of the third electronic device may generate the guidance information by superimposing the augmented reality image on the vehicle image.

Through this, it may be confirmed which direction the vehicle must go to reach the reserved parking space.

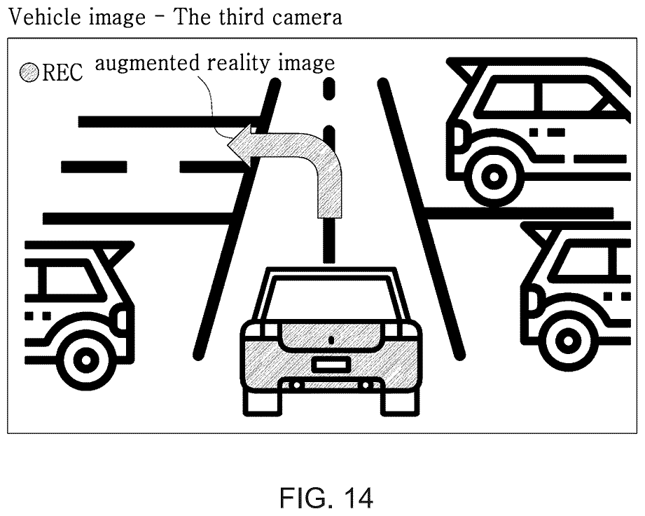

FIG. 14 is a view illustrating guidance information in which an augmented reality image is superimposed on a vehicle image according to an embodiment of the present invention.

Referring to FIG. 14, the augmented reality image may be an arrow image indicating where to go on the route information based on the location of the vehicle in the vehicle image.

Accordingly, users may intuitively understand where to go from locations thereof.

However, Here, when the user's vehicle is not parked in the reserved space, it is necessary to guide the user to the correct parking space.

For this purpose, Here, the processor 110-2 assigns a unique identification ID to each parking space in the parking lot. The processor 110-2 derives the final parking space of the vehicle based on the vehicle image. The processor 110-2 compares the first identification ID corresponding to the final parking space with the second identification ID corresponding to the reserved parking space. Accordingly, the processor 110-2 may confirm whether the vehicle is parked in the reserved parking space.

Accordingly, when the final parking space of the vehicle is different from the reserved parking space, the processor 110-2 may transmit information indicating that the final parking space is different from the reserved parking space and route information for the reserved parking space to the user terminal 200.

Here, there is no problem when the user moves to the parking space he or she has reserved, but when he or she parks in a space he or she has not reserved despite being given instructions, it is necessary to give him or her a disadvantage.

Accordingly, when the final parking space is different from the reserved parking space even after the preset time has elapsed, the processor 110-2 may generate a first surcharge in which preset first surcharge information is reflected in the reserved parking cost corresponding to the reservation information and transmit the same to the user terminal 200.

Here, the above time is a time that may be moved and may be set arbitrarily by the operator. For example, it may be set to 10 minutes, 5 minutes, etc.

In addition, the first surcharge information may be arbitrarily set by the operator. For example, the first surcharge information may be set to 10% or 20%. The first surcharge may be the cost increased by the first surcharge information on the above reserved parking fee.

The reserved parking fees will be described later.

Also, when a user does not remove the vehicle even after the reservation time has passed, it may cause inconvenience to subsequent reservation users. Therefore, it is necessary to provide disadvantages to users who do not remove the vehicle even after the reservation time has passed.

To this end, the processor 110-2 calculates a first parking fee corresponding to the exceeded time when the vehicle is located in the reserved parking space beyond the reserved time. The processor 110-2 may generate a second surcharge fee in which preset second surcharge information is reflected in the first parking fee and transmit it to the user terminal 200.

Here, the first parking fee may be calculated according to the time exceeded in the manner of calculating the reserved parking fee. The second surcharge information may be arbitrarily set by the operator. For example, the second surcharge information may be set to 10%, 20%, etc. The second surcharge cost may be a cost that increases by the second surcharge information to the first parking fee.

Here, the reserved parking fee may be calculated based on the reserved time received from the user terminal 200, the preset basic hourly parking fee, the preset time differential index differentially set for each hour, and the preset location differential index differentially set for each reserved parking space and parking lot parking space.

Through this, parking fees may be applied differentially depending on the time of day when there are many vehicles and the time when there are few vehicles. Parking fees may also be applied differentially to spaces with high and low user preference, such as parking spaces near entrances or elevators.

*More specifically, the above reserved parking fee may be calculated using the mathematical formula 1 below.

$$RPF = IoPS \cdot {\sum }_{n = 1}^{k} ( SPF \times IoT\_n ) . \qquad [ Mathematical formula 1 ]$$

Here, RPF (Reservation Parking Fee) may refer to the reservation parking fee. IoPS (Index of Parking Space) may refer to the location difference index of the parking space corresponding to the reservation parking space. SPF (Standard Parking Fee) may refer to the basic parking fee per hour that is set. IT (Index of Time)_n may refer to the time difference index corresponding to the nth hour among the reservation times. k may mean the total time (Hour) included in the reservation time.

Here, the time difference index may be calculated by the mathematical formula 2 below.

$$IoT\_n = 1.5 \cdot \frac{NoOPS}{NoTPS} - \frac{NoOPS}{NoTPS} \cdot {e}^{- ( \frac{NoE \_ n}{NoD \_ n} )} . \qquad [ Mathematical formula 2 ]$$

Here, NoOPS (Number of Occupied Parking Space) may refer to the average number of vehicles parked inside the parking lot at the nth time. NoTPS (Number of Total Parking Space) may refer to the total number of parking spaces in the parking lot. NoD (Number of Departures)_n may refer to the number of vehicles that departed the parking lot at the nth time. NoE (Number of Entrances)_n may refer to the number of vehicles that entered the parking lot at the nth time.

Here, the position difference index may be calculated by the mathematical formula 3 below.

$$IoPS = \frac{NoSPS}{NoASPS} . \qquad [ Mathematical Formula 3 ]$$

Here, NoSPS (Number of Selection of Parking Space) may refer to the number of times that all users have selected to reserve a parking space corresponding to the reserved parking space during a preset period. NoASPS (Number of Average Selection of Parking Space) may refer to the average number of times that all users have selected to reserve all parking spaces in the parking lot during a preset period.

As mentioned above, only vehicles that have made reservations may be considered to use the parking lot. However, vehicles that visit temporarily, such as delivery vehicles or courier vehicles, need to be viewed differently.

Since the vehicles may impede traffic flow due to disorderly stopping, etc., the processor may set parking spaces where temporarily parked vehicles, such as delivery vehicles or courier vehicles, may park in advance as temporary parking spaces. In order to guide temporarily parked vehicles, such as delivery vehicles or courier vehicles, to the temporary parking spaces, the reserved parking spaces for the temporarily parked vehicles may be set as the temporary parking spaces.

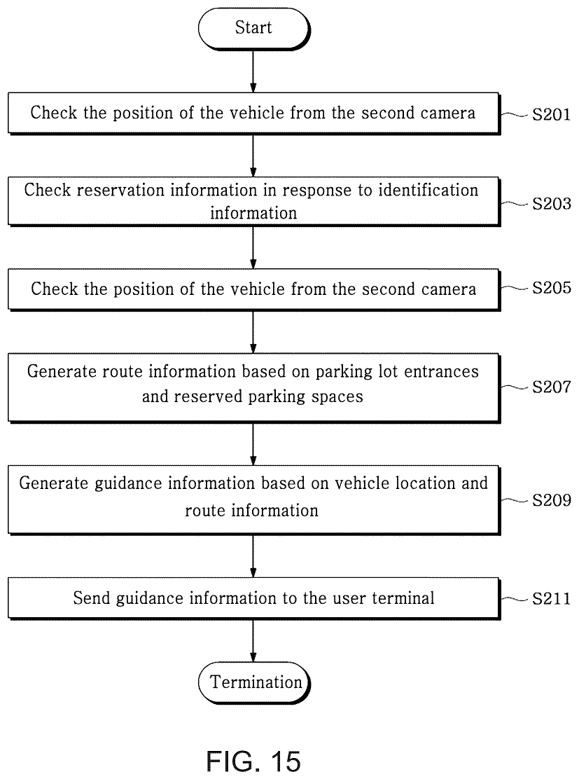

FIG. 15 is a flow chart of a method for providing an artificial intelligence-based vehicle parking reservation and guidance service according to an embodiment of the present invention.

Referring to FIG. 15, a method for providing an artificial intelligence-based vehicle parking reservation and guidance service according to an embodiment of the present invention may receive identification information of an entering vehicle from a first camera installed at the entrance to a parking lot in operation S201.

Also, the method for providing an artificial intelligence-based vehicle parking reservation and guidance service according to an embodiment of the present invention may check reservation information for a reservation time and a reserved parking space in response to the identification information in operation S203.

Also, the method for providing an artificial intelligence-based vehicle parking reservation and guidance service according to an embodiment of the present invention may confirm the location of the vehicle from a plurality of second cameras installed inside the parking lot in operation S205.

Also, the method for providing an artificial intelligence-based vehicle parking reservation and guidance service according to an embodiment of the present invention may generate route information based on the location of the entrance and exit of the parking lot and the reserved parking space in operation S207.

Also, the method for providing an artificial intelligence-based vehicle parking reservation and guidance service according to an embodiment of the present invention may generate guidance information based on the location of the vehicle and the route information in operation S209.

Also, the method for providing an artificial intelligence-based vehicle parking reservation and guidance service according to an embodiment of the present invention may provide the guidance information to a user terminal driving the vehicle in operation S211.

Also, the method for providing an artificial intelligence-based vehicle parking reservation and guidance service according to an embodiment of the present invention may be configured identically to the artificial intelligence-based vehicle parking reservation and guidance service providing device 100-2 disclosed in FIGS. 10 to 14.

### Edge AI-Based Forest Fire Precision Detection and Response Device and Method

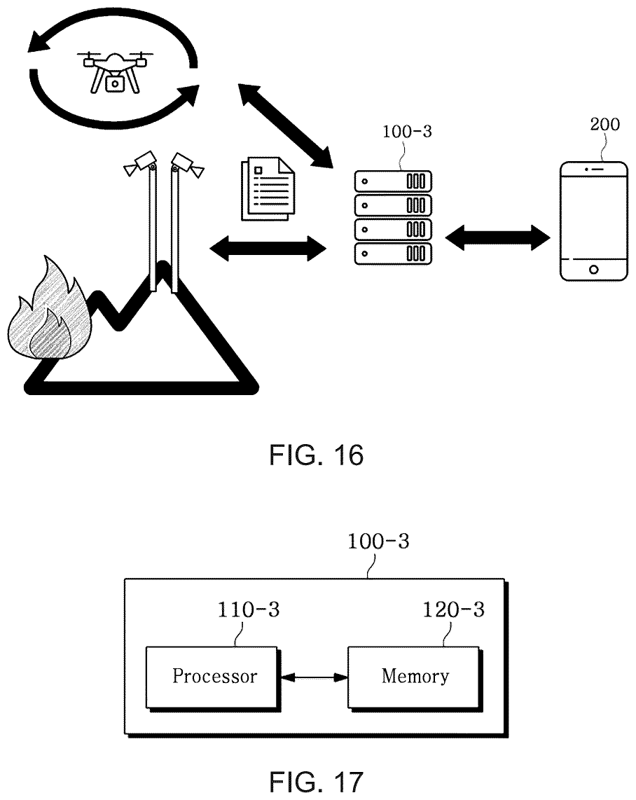

FIG. 16 is a conceptual view of an edge artificial intelligence-based forest fire precision detection and response device 100-3 according to an embodiment of the present invention.

Referring to FIG. 16, the edge AI-based forest fire precision detection and response device 100-3 according to an embodiment of the present invention may perform a situation determination operation based on object information. In addition, the edge AI-based forest fire precision detection and response device 100-3 is not a central control device on a network, but a device installed locally to implement AI-based control and/or processing. Specifically, the edge AI-based forest fire precision detection and response device 100-3 confirms that a fire has occurred based on an image from a camera installed on a mountain. The edge AI-based forest fire precision detection and response device 100-3 may provide information on the current fire status to a user terminal 200 used by a forest fire manager, i.e., an operator, to enable an immediate response.

Meanwhile, the edge artificial intelligence-based forest fire precision detection and response device 100-3 may also be referred to as an ‘electronic device 100-3’ in the present invention.

FIG. 17 is a block diagram of an electronic device 100-3 according to an embodiment of the present invention.

The electronic device 100-3 according to an embodiment includes a processor 110-3 and a memory 120-3. In addition, the electronic device 100-3 may include a processor 110-3, a memory 120-3, and a camera. The processor 110-3 may perform at least one of the above-described methods. The memory 120-3 may store information related to the above-described method or may store a program in which the above-described method is implemented. The memory 120-3 may be a volatile memory or a non-volatile memory. The memory 120-3 may be referred to as a ‘database’, a ‘storage’, or the like.

The processor 110-3 may execute a program and control the electronic device 100-3. The code of the program executed by the processor 110-3 may be stored in the memory 120-3. The electronic device 100-3 may be connected to an external device (e.g., a personal computer or a network) through an input/output device (not shown) and exchange data.

Here, the processor 110-3 may receive shooting data from a camera installed on the mountain.

*Here, the camera may be composed of a general visible light camera and a thermal imaging camera capable of detecting temperature as described below.

Also, the processor 110-3 may analyze the photographed data through the artificial intelligence module to extract a gaseous cloud object. The processor 110-3 may analyze an image of the object captured by the camera to extract a gaseous cloud object. When the processor 110-3 determines that the gaseous cloud object is a real gas, the processor 110-3 may receive thermal image data from the camera.

Also, the processor 110-3 may analyze the above-described shooting data and the above-described gaseous cloud object to determine whether the above-described gaseous cloud object is caused by fire. This will be described later.

Also, when the gaseous cloud object is determined to be caused by a fire, the processor 110-3 may derive the origin point of the gaseous cloud object and transmit the origin point and the fire determination result to the user terminal 200.

Here, when the gaseous cloud object is judged to be caused by a fire, the operator may control a drone installed in advance to take pictures of the area near the origin so that the operator may more accurately determine whether there is a fire. The drone shooting data taken by the drone may be provided to the operator.

In more detail, when the processor 110-3 determines that the gaseous cloud object is caused by a fire, it sends a control command to the installed drone to take a picture of the origin. The drone shooting data taken by the drone may be transmitted to the user terminal 200.

Here, the origin point may be set as the point with the highest temperature within the gaseous cloud object, as described later.

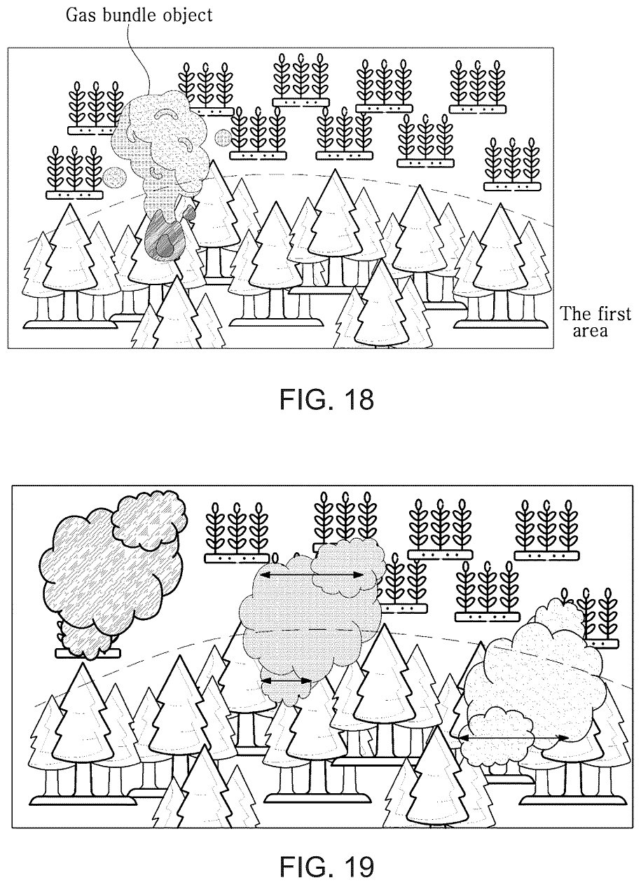

FIG. 18 is an exemplary view of a photographed image according to an embodiment of the present invention.

Referring to FIG. 18, a camera installed on a mountain may capture images of the mountain and other areas, as well as the non-mountain area. As described below, in order to determine whether a fire occurred on a mountain, the processor 110-3 may divide the captured data into a first area corresponding to the mountain and a second area corresponding to other areas.

Here, even when a gaseous cloud object is extracted from the shooting data, it may not be immediately determined that fire occurs. This is because it may be a stain on the camera lens or a gas cloud unrelated to the fire, such as fog.

Therefore, in the present invention, it is possible to determine whether a fire has occurred by sequentially checking whether the gaseous cloud object originated from a mountain, whether it is an actual gaseous cloud, i.e., a true gas, or whether it originated from a fire.

FIG. 19 is an exemplary view for determining the origin of a gaseous cloud object according to an embodiment of the present invention.

Referring to FIG. 19, the processor 110-3 may set a narrowest width of upper and lower portions of the gaseous cloud object within the shooting data as the origin direction criterion.

Also, when the boundary of the gaseous cloud object is entirely included in the first area, the processor 110-3 may determine that the gaseous cloud object originated from a mountain.

Also, when the boundary of the gaseous cloud object touches the boundary line between the first and second regions and the origin direction reference is located toward the first region, the processor 110-3 may determine that the gaseous cloud object originated from a mountain. This is because gas has the characteristic of diffusing as it rises, and thus it may be considered to have originated from a point where it is least diffused.

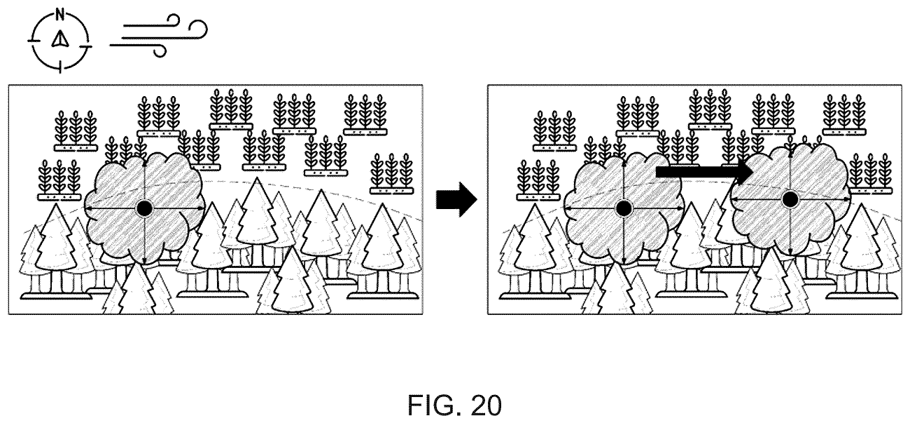

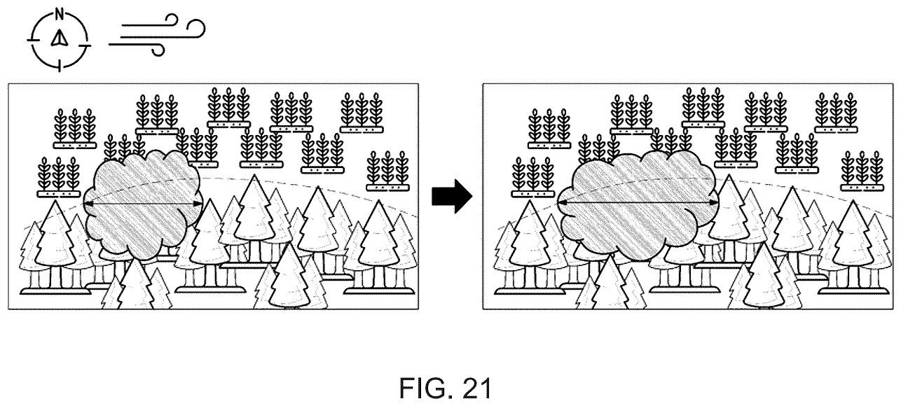

FIGS. 20 and 21 are exemplary views for determining whether a gaseous cloud object is a true gas according to an embodiment of the present invention.

As described above, when a gaseous cloud object is determined to have originated from a mountain, it is necessary to determine whether the gaseous cloud object is a stain or a true gas such as smoke or fog.

Here, referring to FIGS. 20 and 21, the processor 110-3 may receive information on wind direction and wind speed from a wind meter installed on the mountain in order to determine whether the gaseous cloud object is a stain or a true gas such as smoke or fog. The processor 110-3 may derive a first object center where the first maximum horizontal width and the first maximum vertical width of the gaseous cloud object meet at a first point in time. The processor 110-3 may derive a second object center where the second maximum horizontal width and the second maximum vertical width of the gaseous cloud object meet at a second point in time when a preset time has elapsed from the first point in time.

Also, the processor 110-3 may analyze the image of the object captured by the camera to extract the gaseous cloud object. When the gaseous cloud object is determined to be a real gas, the processor 110-3 may receive thermal image data from the camera. The processor 110-3 may compare a first center movement distance preset on the angle of the camera based on the wind speed and a second center movement distance between the first object center and the second object center on the angle of the camera. The processor 110-3 may compare the wind direction and the direction of the second center movement distance. Here, when the direction of the second center movement distance is included within the wind direction and the preset first error range, and the second center movement distance is included within the first center movement distance and the preset second error range, the processor 110-3 may determine that the gaseous cloud object is a true gas such as smoke or fog.

This is to see how the gaseous cloud object moves over time. In the case of a real gas, the center moves depending on the wind speed and direction.

Here, the first center movement distance may be set to the average movement distance of the gas cluster object according to the wind speed based on the entire collected database.

Here, the first error range and the second error range may be arbitrarily set by the operator. The first error range and the second error range may be set to 10%, 20%, etc.

Also, when the direction of the second center displacement distance is within the wind direction and the first error range, but the second center displacement distance is outside the first center displacement distance and the second error range, the processor 110-3 may select one of the longest horizontal width or longest vertical width that is closer to the wind direction. The processor 110-3 may derive a gas diffusion change rate corresponding to a ratio of the second longest horizontal width or second longest vertical width to the selected first longest horizontal width or first longest vertical width. When the gas diffusion change rate is within a preset third error range and a preset reference diffusion change rate corresponding to the diffusion degree of smoke or fog based on the wind speed, the processor 110-3 may determine that the gas cloud object is a true gas such as smoke or fog.

Here, the reference diffusion change rate may be set to the average gas diffusion change rate of the gas cloud object according to the wind speed based on the entire collected database.

Here, the third error range may be arbitrarily set by the operator. The third error range may be set to 10%, 20%, etc.

Through this, it is possible to determine whether a gas clous object is truly gas based on the diffusion of the gas cluster even when the center of the gas cloud object has not moved sufficiently.

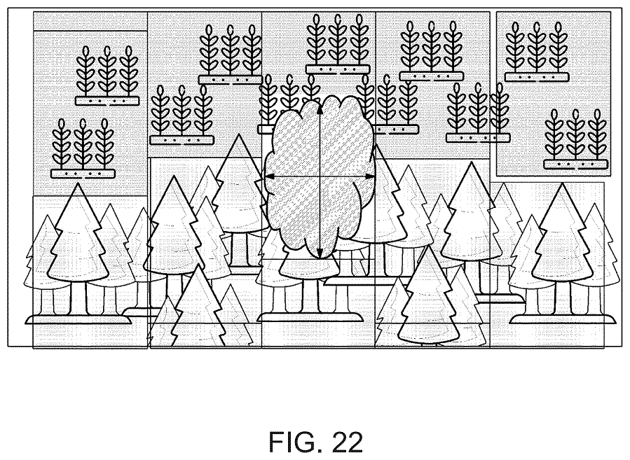

FIG. 22 is an exemplary view for determining whether the gaseous cloud object is caused by a fire according to an embodiment of the present invention.

As described above, when the gaseous cloud object is determined to be a true gas such as smoke or fog, it is necessary to receive thermal image data from the camera and determine whether the gaseous cloud object is caused by a fire based on the thermal image data.

Accordingly, referring to FIG. 22, the processor 110-3 may generate a first block including a gaseous cloud object, in which the longest horizontal width and longest vertical width of the gaseous cloud object are the horizontal length and the vertical length, respectively, in the photographed data, in order to determine whether the gaseous cloud object is caused by fire. The processor 110-3 may divide the first area into a plurality of second blocks having the same size as the first block, and may divide the second area into a plurality of third blocks having the same size as the first block.

Here, depending on the size of the above-mentioned photographed image and the size of the first block, it may not be divided exactly as in FIG. 22. Here, blocks are first arranged based on the boundary line between the first area and the second area. In the remaining area, blocks adjusted according to the size of the remaining area may be arranged.

Also, the processor 110-3 may derive a first maximum temperature from the first block based on the thermal image data. The processor 110-3 may derive a second maximum temperature for each of the second blocks based on the thermal image data and calculates a first average value corresponding to the average value of the second maximum temperatures. The processor 110-3 may derive a third maximum temperature for each of the third blocks based on the thermal image data and calculates a second average value corresponding to the average value of the third maximum temperatures.

In order to determine whether it is caused by a fire, the temperature must be extracted. This is done by dividing it into uniform areas and collecting the maximum temperature for each to accurately determine whether there is a fire.

Here, when the first maximum temperature exceeds the preset first threshold temperature, the processor 110-3 may determine that the gaseous cloud object is due to a fire and compare the first maximum temperature with the first average value. When the difference between the first maximum temperature and the first average value is within the preset fourth error range, the processor 110-3 may determine that there is a high possibility of a large-scale forest fire. The processor 110-3 may transmit information indicating that a fire has occurred to a preset related organization or control center and the user terminal 200.

This is because the temperature of the mountain area adjacent to the first block has already risen significantly, and there is a possibility of a large-scale forest fire. Therefore, information about the fire outbreak may be immediately transmitted to relevant organizations such as 119, which may extinguish the fire at the same time as notifying the operator, so that an immediate response may be made.

Here, the first critical temperature may be set to the average value of the air temperature at a point 20 m above the point of fire occurrence when fire occurs. For example, the temperature of the fire, that is, the fire, starts at a minimum of 500 degrees, but the temperature may be somewhat lowered as it spreads into the air. Therefore, it may be set as described above to detect the fire in the photographed image. For example, it may be set to 100 degrees.

Here, the fourth error range may be arbitrarily set by the operator. The fourth error range may be set to 10%, 20%, etc.

Also, when the difference between the first highest temperature and the first average value is outside the fourth error range, the processor 110-3 determines that the fire is localized. The processor 110-3 transmits a control command to the drone to photograph the origin point. The processor 110-3 may transmit the drone photographing data photographed by the drone to the user terminal 200.

Also, when the first maximum temperature is lower than or equal to the first threshold temperature and exceeds the second threshold temperature, which is preset to be lower than the first threshold temperature, the processor 110-3 may compare the first maximum temperature with the first average value and the second average value. When the difference between the first maximum temperature and the first average value and the second average value is within the fourth error range, the processor 110-3 may determine that the temperature rise is due to the weather and transmit the determination result to the user terminal 200.

This is because the temperature of the gaseous cloud object and the area outside the mountain and the mountain are all similar, so it may be seen that the temperature rose due to the weather. It is difficult to see that the gaseous cloud object is caused by fire.

Here, the second critical temperature may be arbitrarily set by the operator. For example, the second critical temperature may be set to 50 degrees.

Also, when the first maximum temperature and the first average value are within the fourth error range, and the first maximum temperature and the second average value are outside the fourth error range, the processor 110-3 determines that there is a high possibility of fire. The processor 110-3 may transmit a control command to the drone to photograph the origin point, and transmit the drone photographing data photographed by the drone to the user terminal 200.

Since the temperature is high only in the first area close to the gaseous cloud object, it is difficult to see it as a temperature rise due to weather. Therefore, it is desirable to use a drone to photograph the origin and have the operator confirm it.

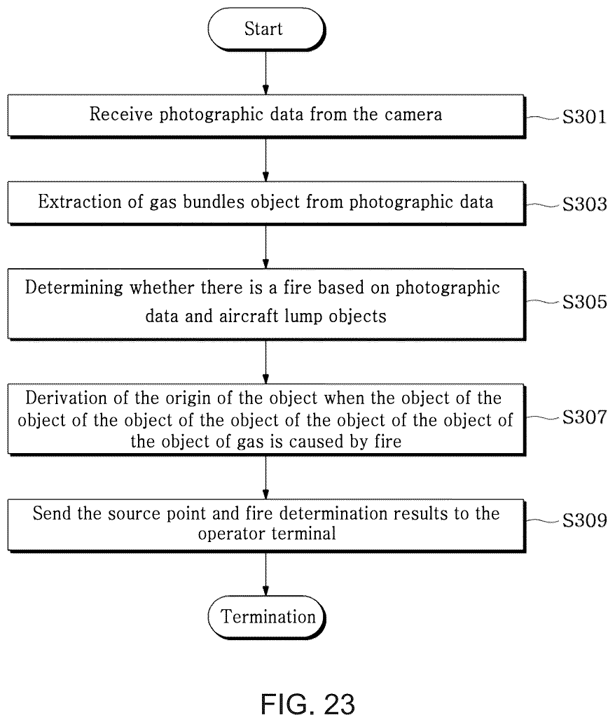

FIG. 23 is a flow chart of a forest fire precision detection and response method based on edge artificial intelligence according to an embodiment of the present invention.

Referring to FIG. 23, a forest fire precision detection and response method based on edge artificial intelligence according to an embodiment of the present invention may receive shooting data from a camera installed on a mountain in operation S301.

Also, the method for precise forest fire detection and response based on edge artificial intelligence according to an embodiment of the present invention may extract a gas cloud object by analyzing the shooting data through an artificial intelligence module in operation S303.

Also, the forest fire precision detection and response method based on edge artificial intelligence according to an embodiment of the present invention may analyze the photographed data and the gaseous cloud object to determine whether the gaseous cloud object is caused by a fire in operation S305.

Also, according to an embodiment of the present invention, the method for precise forest fire detection and response based on edge artificial intelligence may derive the origin point of a gaseous cloud object when it is determined that the gaseous cloud object is caused by a fire in operation S307.

Also, the edge artificial intelligence-based forest fire precision detection and response method according to an embodiment of the present invention may transmit the origin point and fire determination result to the user terminal 200 in operation S309.

Also, the edge artificial intelligence-based forest fire precision detection and response method according to an embodiment of the present invention may be configured identically to the edge artificial intelligence-based forest fire precision detection and response device 100-3 disclosed in FIGS. 16 to 22.

### Traffic Accident Analysis System and Method

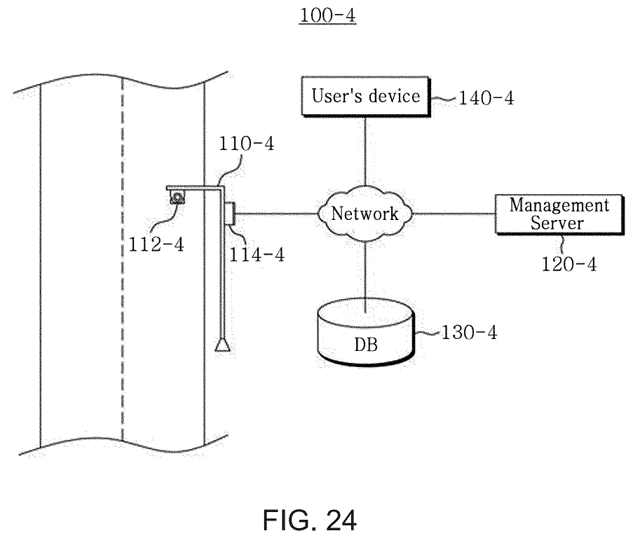

FIG. 24 is a schematic view illustrating a traffic accident analysis system according to an embodiment of the present disclosure.

As illustrated in FIG. 24, the traffic accident analysis system 100-4 includes a camera 112-4, a video surveillance device 114-4, a management server 120-4, a database (DB) 130-4, and a user terminal 200.

The camera 112-4 is installed on the smart pole 110-4 and captures various traffic images occurring on the road. The camera 112-4 is, for example, a device capable of capturing still images and moving images, and according to an embodiment, may include one or more image sensors, a lens, an image signal processor (ISP), or a flash (e.g., an LED or xenon lamp, etc.). The camera 112-4 may generate a road traffic image signal corresponding to an input external image and output it to the image surveillance device 114-4. The image of the camera 112-4 used in the present disclosure is a road traffic image captured from above by being installed on the smart pole 110-4, and may obtain information on a wider space than the black box image of the vehicle.

The video surveillance device 114-4 may also be installed on the smart pole 110-4 and may monitor traffic accidents occurring on the road, including vehicle accidents, pedestrians, or a combination thereof, from road traffic images captured by the camera 112-4. The video surveillance device 114-4 may calculate the distance and angle from the camera 112-4 image to the vehicle through planar processing of the image in the event of a traffic accident, generate a planar traffic accident image, and provide the image to the management server 120-4. Meanwhile, the video surveillance device 114-4 may compare the planar traffic accident image with a standard traffic accident image to determine how similar the planar traffic accident image is to at least one of the standard traffic accident images.

The management server 120-4 may manage traffic accident-related videos together with road traffic videos received from each video surveillance device 114-4 installed in a plurality of smart poles 110-4. The management server 120-4 may store traffic accident-related videos together with the received road traffic videos in a database 130-4.

A plurality of standard traffic accident images may be stored in the database 130-4. Accordingly, a plurality of standard traffic accident information and a plurality of actual traffic accident images may be stored in the database 130-4. Here, the standard traffic accident information may include traffic accident data provided by the Road Traffic Authority, etc., and may include the negligence ratio established by court precedents, etc.

The user terminal 140-4 is an electronic device for displaying the similarity of an actual traffic accident video, for example, the type of accident and the cause of the accident. The user terminal 140-4 may receive and display an actual traffic accident video and a standard traffic accident video similar to the actual traffic accident video from a video surveillance device 114-4 or a management server 120-4 and display the similarity and the fault ratio. Here, the user terminal 140-4 may be an electronic device of the Non-life Insurance Association or an electronic device of an accident party.

In FIG. 24, it is described that the traffic accident similarity is estimated by the video surveillance device 114-4, but the traffic accident similarity estimation may also be processed by the management server 120-4. Therefore, the traffic accident analysis system may be the video surveillance device 114-4 or the management server 120-4. Meanwhile, in FIG. 24, the management server 120-4 and the database 130-4 are depicted separately, but the database function may be implemented in the management server 120-4.

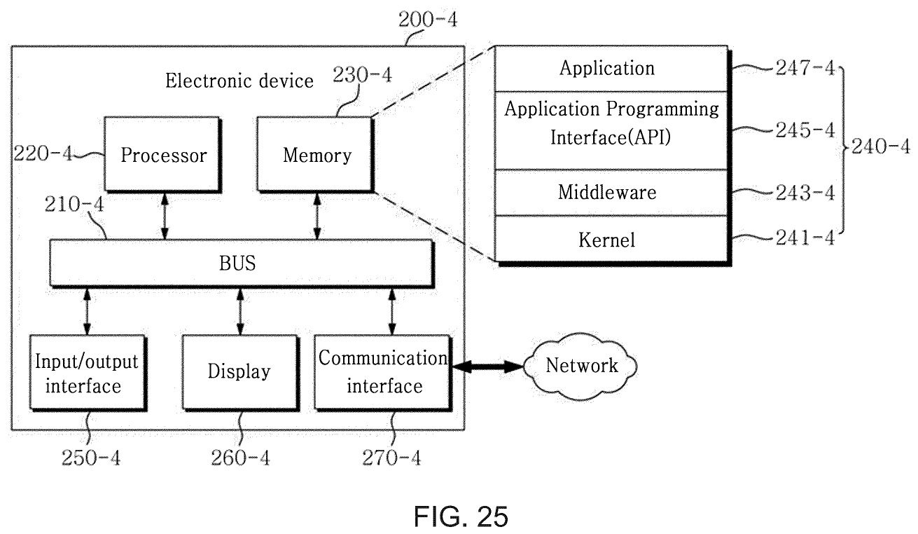

FIG. 25 is a block diagram illustrating a case where the video surveillance device or management server illustrated in FIG. 24 operates as a general electronic device.

As illustrated in FIG. 25, an electronic device 200-4 connected to a network is described. The electronic device 200-4 may include a bus 210-4, a processor 220-4, a memory 230-4, an input/output interface 250-4, a display 260-4, and a communication interface 270-4. In some embodiments, the electronic device 200-4 may omit at least one of the components or may additionally include other components. The bus 210-4 may include a circuit that connects the components 220-4-270-4 to each other and transmits communication (e.g., control messages or data) between the components. The processor 220-4 may include one or more of a central processing unit, an application processor, or a communication processor (CP). The processor 220-4 may, for example, perform operations or data processing related to control and/or communication of at least one other component of the electronic device 200-4.

The memory 230-4 may include volatile and/or nonvolatile memory. The memory 230-4 may store, for example, instructions or data related to at least one other component of the electronic device 200-4. According to an embodiment, the memory 230-4 may store software and/or a program 240-4. The program 240-4 may include, for example, a kernel 241-4, a middleware 243-4, an application programming interface (API) 245-4, and/or an application program (or “application”) 247-4. At least a portion of the kernel 241-4, the middleware 243-4, or the API 245-4 may be referred to as an operating system. The kernel 241-4 may control or manage system resources (e.g., a bus 210-4, a processor 220-4, or a memory 230-4) used to execute operations or functions implemented in other programs (e.g., a middleware 243-4, an API 245-4, or an application program 247-4). In addition, the kernel 241-4 may provide an interface that allows the middleware 243-4, the API 245-4, or the application program 247-4 to control or manage system resources by accessing individual components of the electronic device 200-4.

The middleware 243-4 may, for example, act as an intermediary to enable an API 245-4 or an application program 247-4 to communicate with the kernel 241-4 to exchange data. In addition, the middleware 243-4 may process one or more work requests received from the application program 247-4 according to priority. For example, the middleware 243-4 may grant a priority for using system resources (e.g., a bus 210, a processor 220-4, or a memory 230-4) of the electronic device 200-4 to at least one of the application programs 247-4 and process the one or more work requests. The API 245-4 is an interface for the application 247-4 to control functions provided by the kernel 241-4 or middleware 243-4, and may include at least one interface or function (e.g., command) for, for example, file control, window control, image processing, or character control. The input/output interface 250-4 may, for example, transmit a command or data input from a user or another external device to another component(s) of the electronic device 200-4, or output a command or data received from another component(s) of the electronic device 200-4 to a user or another external device.

The display 260-4 may include, for example, a liquid crystal display (LCD), a light emitting diode (LED) display, an organic light emitting diode (OLED) display, a micro electro mechanical systems (MEMS) display, or an electronic paper display. The display 260-4 may, for example, display various contents (e.g., text, images, videos, icons, and/or symbols) to a user. The display 260-4 may include a touch screen and may receive touch, gesture, proximity, or hovering inputs, for example, using an electronic pen or a part of the user's body.

The communication interface 270-4 may establish communication with, for example, another electronic device (not shown). For example, the communication interface 270-4 may be connected to a network via wireless communication or wired communication to communicate with the other electronic device. Here, the wireless communication may include, for example, cellular communication using at least one of LTE, LTE-A (LTE Advance), CDMA (code division multiple access), WCDMA (wideband CDMA), UMTS (universal mobile telecommunications system), WiBro (Wireless Broadband), or GSM (Global System for Mobile Communications). According to an embodiment, the wireless communication may include, for example, at least one of WiFi (wireless fidelity), Bluetooth, Bluetooth low energy (BLE), Zigbee, near field communication (NFC), Magnetic Secure Transmission, Radio Frequency (RF), or Body Area Network (BAN). According to an embodiment, the wireless communication may include GNSS. GNSS may be, for example, GPS (Global Positioning System), Glonass (Global Navigation Satellite System), Beidou Navigation Satellite System (hereinafter, referred to as “Beidou”), or Galileo, the European global satellite-based navigation system. Hereinafter, in this document, “GPS” may be used interchangeably with “GNSS”. The wired communication may include, for example, at least one of USB (universal serial bus), HDMI (high definition multimedia interface), RS-232 (recommended standard232), power line communication, or POTS (plain old telephone service). The network 262-4 may include at least one of a telecommunications network, for example, a computer network (e.g., LAN or WAN), the Internet, or a telephone network.

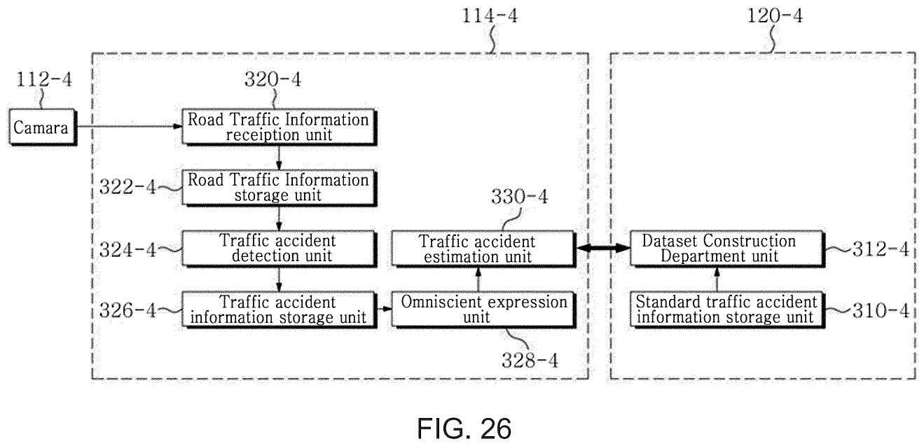

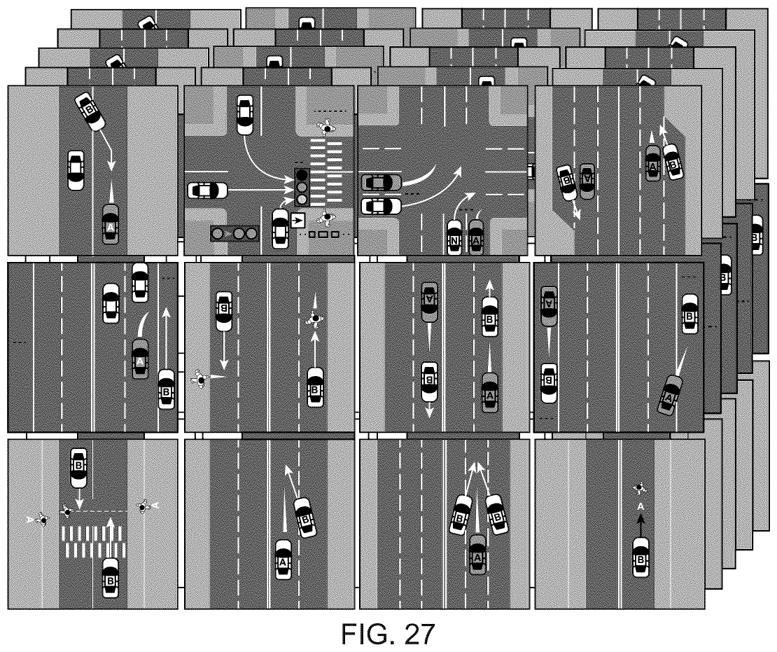

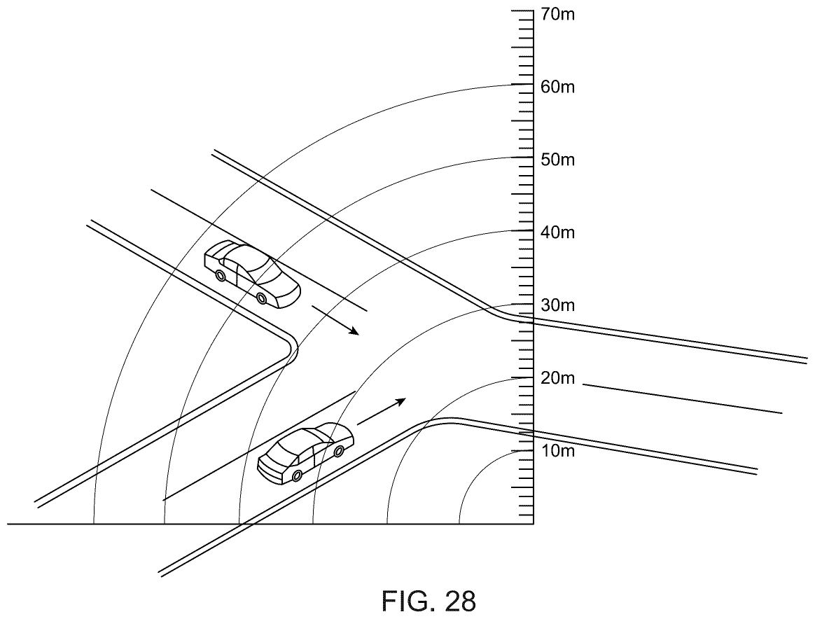

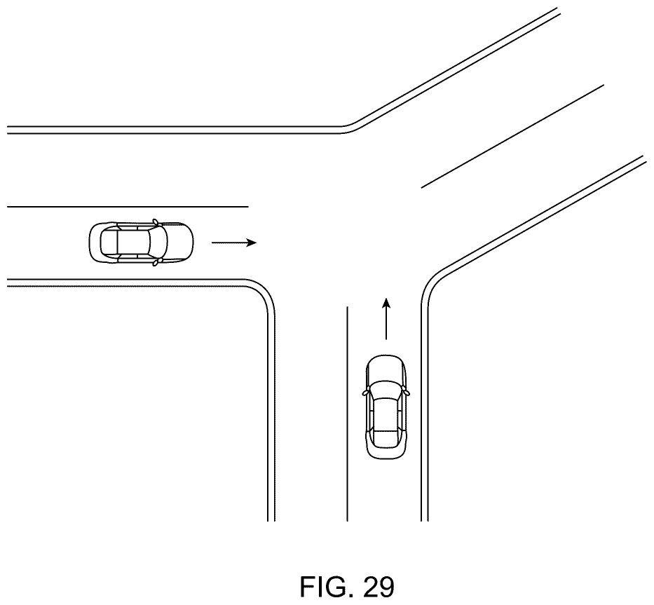

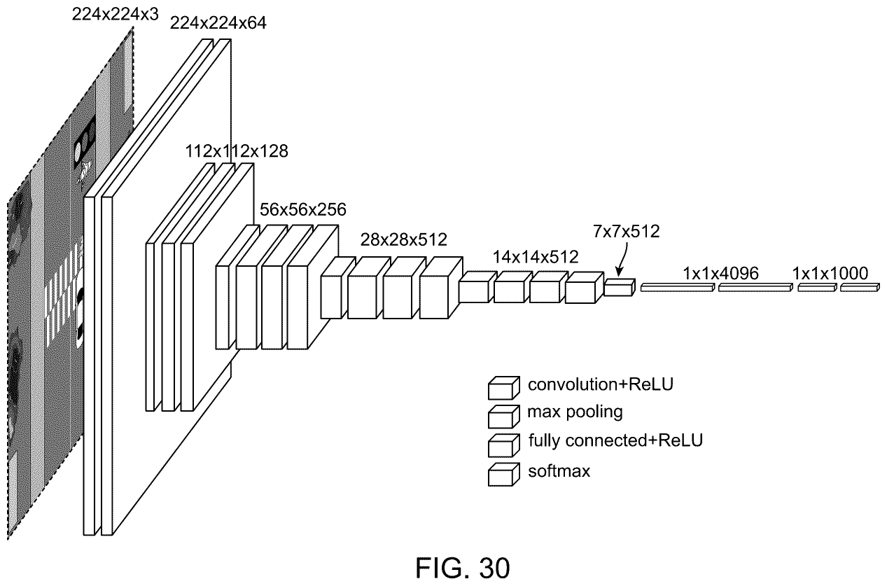

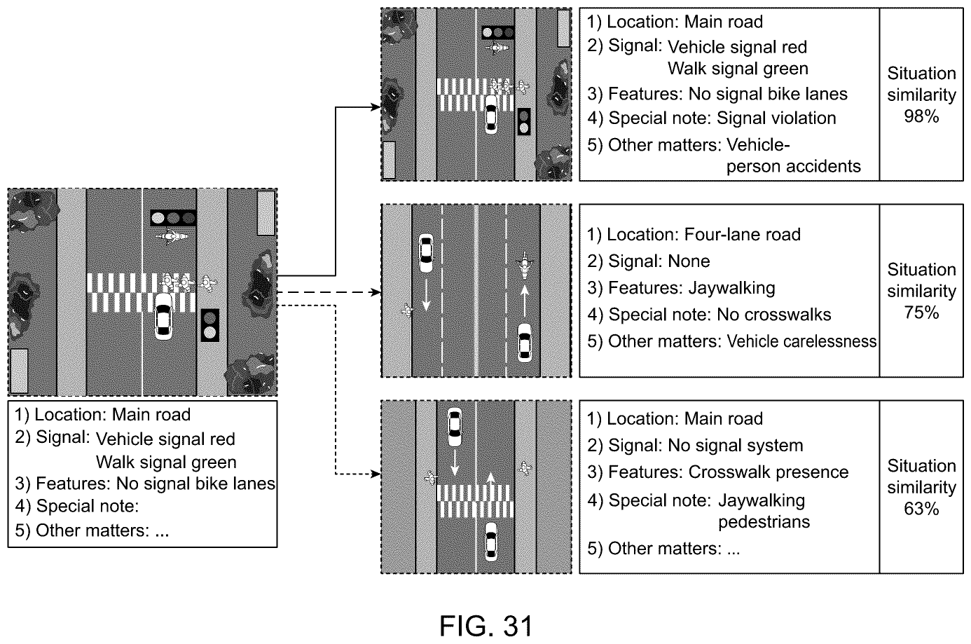

FIG. 26 is a block diagram of a traffic accident analysis system according to an embodiment of the present disclosure. FIG. 27 is an exemplary view of two-dimensional images by type and/or situation of a standard traffic accident according to an embodiment of the present disclosure. FIGS. 28 and 29 are diagrams illustrating examples of matching camera images to a Naver map according to an embodiment of the present disclosure. FIG. 30 is an exemplary view illustrating an example of estimating a standard traffic accident type of an actual traffic accident situation according to an embodiment of the present disclosure. FIG. 31 is an exemplary view of displaying a standard traffic accident estimation result of an actual traffic accident situation according to an embodiment of the present disclosure.

As illustrated in FIG. 26, the traffic accident analysis system 100-4 may include a camera 112-4, a video surveillance device 114-4, and a management server 120-4.

The management server 120-4 may include a standard traffic accident information storage unit 310-4 and a data set construction unit 312-4. A plurality of standard traffic accident information that is generally used is stored in the standard traffic accident information storage unit 310-4. Here, standard traffic accident information may include traffic accident data provided by the Road Traffic Authority, etc., and may include negligence ratios established by court precedents, etc. Examples of two-dimensional images of types and/or situations of standard traffic accidents according to embodiments of the present disclosure are illustrated in FIG. 27.

According to the present invention, the processor 110-4 constructs a dataset from standard traffic accident information, and maps an image of an object of actual traffic accident information captured by a camera into a two-dimensional flat map. The processor 110-4 compares the dataset with the actual traffic accident information to estimate standard traffic accident information similar to the actual traffic accident information. Specifically, the dataset construction unit 312-4 constructs a dataset to be used by the traffic accident estimation unit 330-4. To this end, the dataset construction unit 312-4 may first classify traffic accident types that may occur on the road, such as vehicle-to-vehicle (vehicle to vehicle), vehicle-to-person (vehicle to pedestrian), vehicle-to-two-wheeler (vehicle to two-wheeler), and vehicle-to-bicycle (vehicle to bicycle), using an image of the standard traffic accident information. The dataset construction unit 312-4 may perform labeling on traffic accident images using images in which traffic accident types are classified. Here, labeling may be passenger cars, trucks, buses, and ambulances when the vehicle is the standard, and adults, elderly people, and children when the person is the standard. In addition, the dataset construction unit 312-4 may use text data, which is explanatory material explaining the traffic accident, in addition to the traffic accident video. In this case, the dataset may include video and text. Meanwhile, the dataset construction unit 312-4 may construct the dataset by introducing artificial intelligence modeling and comparing and evaluating a large number of actual traffic accident data.

The video surveillance device 114-4 may comprise a road traffic information receiving unit 320-4, a road traffic information storage unit 322-4, a traffic accident identification unit 324-4, a traffic accident information storage unit 326-4, an omniscient expression unit 328-4, and a traffic accident estimation unit 330-4.

The road traffic information receiving unit 320-4 receives real-time road traffic images provided from the camera 112-4.

The road traffic information storage unit 322-4 stores the road traffic images received from the road traffic information receiving unit 320-4. Images stored in the road traffic information storage unit 322-4 may be stored as new files at predetermined time intervals, for example, every 2 minutes. That is, a 2-minute image may be stored as a first file, the next 2-minute image may be stored as a second file, and then another 2-minute image may be stored as a third file. In addition, only the files of the previous 2 images may be maintained and the remaining files may be deleted. Therefore, the files stored in the road traffic information storage unit 322-4 may store the previous 2 files and 1 file being recorded.

The traffic accident identification unit 324-4 identifies whether there is a traffic accident among the road traffic images being recorded. When a traffic accident is identified in the traffic accident identification unit 324-4, the traffic accident identification unit 324 may copy and store the traffic accident information stored in the road traffic information storage unit 322-4 when the traffic accident occurs in the traffic accident information storage unit 326-4. The traffic accident information stored in the traffic accident information storage unit 326-4 may be provided to the management server 120-4.

The omniscient expression unit 328-4 converts traffic accident images from the identification of the accident vehicle to the occurrence of the accident, for example, in units of 1 to 5 seconds, into omniscient expressions among the actual traffic accident information stored in the traffic accident information storage unit 326-4.

The omniscient expression unit 328-4 may first display a circular distance line at a predetermined distance interval, for example, an interval of 1 to 10 meters, on the traffic accident image for omniscient expression of the image. Here, the circular distance line may be a value obtained in advance through an image obtained while installing a camera 112-4 on a smart pole 110-4. The omniscient expression unit 328-4 may then display a bounding box using the boundaries of the identified objects. Here, the bounding box for the vehicle may be used to calculate the direction and angle of travel of the vehicle. The omniscient expression unit 328-4 may then perform a task of matching a two-dimensional map with the actual location of the scene. Here, the two-dimensional flat map may be a Naver map. Accordingly, the location of the vehicle in the traffic accident image may be mapped onto the two-dimensional flat map by considering the distance and angle from the smart pole 110-4. The omniscient expression unit 328-4 may display an accident image as an omniscient expression on a two-dimensional flat map for a predetermined time period, for example, 1 to 5 seconds, from the identification of the accident vehicle to the occurrence of the accident. An example of a camera image according to an embodiment of the present disclosure is illustrated in FIG. 28, and an example matching it to a Naver map is illustrated in FIG. 29.

The processor 220-4 may perform a situation determination operation. The situation determination operation may include the processor 220-4 constructing a dataset through comparison and evaluation with a plurality of real data, learning using the constructed dataset, and estimating the similarity with the image of the object captured by the camera 112-4. Specifically, the traffic accident estimation unit 330-4 may estimate similar standard traffic accident information by learning actual traffic accident information using the standard traffic accident dataset constructed in this way. On the other hand, the traffic accident estimation unit 330-4 may estimate a standard traffic accident similar to the traffic accident and the similarity thereof by learning about the actual traffic accident dataset constructed from actual traffic accident information. In this case, the processor 220-4 may estimate the similarity with the image of the object captured by the camera 112-4 by applying a convolutional neural network. The traffic accident estimation unit 330-4 may analyze the image by applying a convolutional neural network (CNN). CNN includes a part that extracts features of an image while maintaining spatial information of the image and a part that classifies the image in a way that effectively recognizes and emphasizes features from adjacent images. The feature extraction area may include a convolutional layer that finds features of an image while minimizing the number of shared parameters using a filter, and a pooling layer that strengthens and collects features. An example of estimating a standard traffic accident type of an actual traffic accident situation according to an embodiment of the present invention is illustrated in FIG. 30.

Therefore, the traffic accident estimation unit 330-4 may estimate how similar the two-dimensional planar traffic accident image expressed in the omniscient expression unit 328-4 is to at least one of the standard traffic accident images by comparing the planar traffic accident image expressed in the omniscient expression unit 328-4 with the standard traffic accident image. An example of a standard traffic accident estimation result of an actual traffic accident situation according to an embodiment of the present invention is illustrated in FIG. 31.

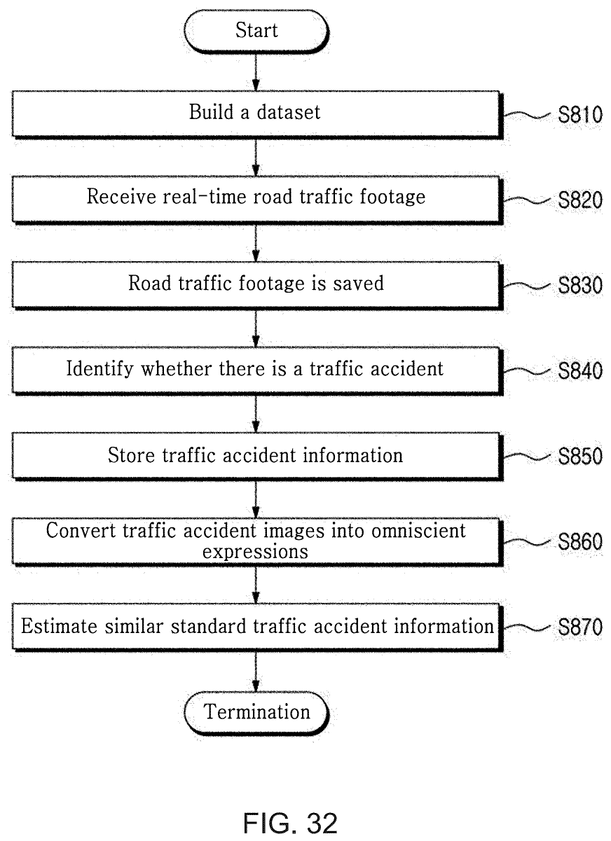

FIG. 32 is a flow chart of a traffic accident analysis method according to another embodiment of the present invention.

The dataset construction unit 312-4 of the management server 120-4 constructs a dataset to be used in the traffic accident estimation unit 330-4 from a plurality of standard traffic accident information stored in the standard traffic accident information storage unit 310-4 in operation S810. To this end, the dataset construction unit 312-4 may first classify traffic accident types that may occur on the road, such as vehicle-to-vehicle (vehicle to vehicle), vehicle-to-person (vehicle to pedestrian), vehicle-to-two-wheeler (vehicle to two-wheeler), and vehicle-to-bicycle (vehicle to bicycle), using images of standard traffic accident information. The dataset construction unit 312-4 may perform labeling on traffic accident images using images in which traffic accident types have been classified. Here, labeling may be passenger cars, trucks, buses, and ambulances when vehicles are the standard, and adults, elderly people, and children when people are the standard. In addition, the dataset construction unit 312-4 may further use text data, which is explanatory material explaining traffic accidents, in addition to traffic accident images. In this case, the dataset may contain images and text.

The road traffic information receiving unit 320-4 of the video surveillance device 114-4 receives real-time road traffic images provided from the camera 112-4 in operation S820. The road traffic information storage unit 322-4 stores the road traffic images received from the road traffic information receiving unit 320-4 in operation S830. For example, images stored in the road traffic information storage unit 322-4 may be stored as new files every two minutes.

The traffic accident identification unit 324-4 identifies whether there is a traffic accident among the recorded road traffic images in operation S840. When a traffic accident is identified in the traffic accident identification unit 324-4, the traffic accident identification unit 324-4 copies and stores the traffic accident information stored in the road traffic information storage unit 322-4 when the traffic accident occurs in the traffic accident information storage unit 326-4 in operation S850. The traffic accident information stored in the traffic accident information storage unit 326-4 may be provided to the management server 120-4.

The omniscient expression unit 328-4 converts a traffic accident image into an omniscient expression from among the actual traffic accident information stored in the traffic accident information storage unit 326-4 for a predetermined time, for example, 1 to 5 seconds, from the identification of the accident vehicle to the occurrence of the accident in operation S860. For the omniscient expression of the image, the omniscient expression unit 328-4 may first display a circular distance line at a predetermined distance interval, for example, 1 to 10 meters, on the traffic accident image. Here, the circular distance line may be a value obtained in advance through an image obtained while installing a camera 112-4 on a smart pole 110-4. The omniscient expression unit 328-4 may then display a bounding box using the boundaries of the identified objects. Here, the bounding box for the vehicle may be used to calculate the direction and angle of travel of the vehicle. The omniscient expression unit 328-4 may then perform a task of matching a two-dimensional map with the actual location of the scene. Here, the two-dimensional flat map may be a Naver map. Accordingly, the vehicle location in the traffic accident video may be mapped to the two-dimensional flat map by considering the distance and angle from the smart pole 110-4. The omniscient expression unit 328-4 may display the accident video as an omniscient expression on the two-dimensional flat map for a predetermined time, for example, 1 to 5 seconds, from the identification of the accident vehicle until the accident occurs.

The traffic accident estimation unit 330-4 estimates similar standard traffic accident information by learning actual traffic accident information using the standard traffic accident data set constructed in this way in operation S870. On the one hand, the traffic accident estimation unit 330-4 may estimate similar standard traffic accidents and their similarity to the corresponding traffic accident by learning about the actual traffic accident data set constructed from actual traffic accident information. In this case, the traffic accident estimation unit 330-4 may analyze the image by applying a convolutional neural network (CNN). The CNN includes a part that extracts features of the image in a way that effectively recognizes and emphasizes features from adjacent images while maintaining the spatial information of the image, and a part that classifies the image. The feature extraction area may include a convolutional layer that finds features of the image while minimizing the number of shared parameters using a filter, and a pooling layer that strengthens and collects the features.

The embodiments described above may be implemented as hardware components, software components, and/or a combination of hardware components and software components. For example, the devices, methods, and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing instructions and responding to them. The processing device may execute an operating system (OS) and one or more software applications running on the OS. In addition, the processing device may access, store, manipulate, process, and generate data in response to the execution of the software. For ease of understanding, the processing device is sometimes described as being used alone, but those skilled in the art will appreciate that the processing device may include multiple processing elements and/or multiple types of processing elements. For example, the processing device may include multiple processors, or a processor and a controller. Other processing configurations, such as parallel processors, are also possible.

The method according to the embodiment may be implemented in the form of program commands that may be executed through various computer means and recorded on a computer-readable medium. The computer-readable medium may include program commands, data files, data structures, etc., alone or in combination. The program commands recorded on the medium may be those specially designed and configured for the embodiment or may be those known to and available to those skilled in the art of computer software. Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program commands such as ROMs, RAMs, and flash memories. Examples of program instructions include machine language code, such as that produced by a compiler, as well as high-level language code that may be executed by a computer using an interpreter, etc. The hardware devices may be configured to operate as one or more software modules to perform the operations of the embodiments, and vice versa.

The software may include a computer program, code, instructions, or a combination of one or more of these. The software may configure a processing device to perform a desired operation or may, independently or collectively, instruct the processing device. The software and/or data may be permanently or temporarily embodied in any type of machine, component, physical device, virtual equipment, computer storage medium or device, or transmitted signal wave, for interpretation by the processing device or for providing instructions or data to the processing device. The software may be distributed over networked computer systems and stored or executed in a distributed manner. The software and data may be stored on one or more computer-readable recording media.

Although the embodiments have been described with limited drawings as described above, those skilled in the art may apply various technical modifications and variations based on the above. For example, even when the described techniques are performed in a different order than the described method, and/or the components of the described system, structure, device, circuit, etc. are combined or combined in a different form than the described method, or are replaced or substituted by other components or equivalents, appropriate results may be achieved.

Therefore, other implementations, other embodiments, and equivalents to the claims are also included in the scope of the claims described below.

The embodiments described above may be implemented as hardware components, software components, and/or a combination of hardware components and software components. For example, the devices, methods, and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing instructions and responding to them. The processing device may execute an operating system (OS) and one or more software applications running on the operating system. In addition, the processing device may access, store, manipulate, process, and generate data in response to the execution of the software. For ease of understanding, the processing device is sometimes described as being used alone. However, one skilled in the art will appreciate that the processing device may include multiple processing elements and/or multiple types of processing elements. For example, the processing device may include multiple processors, or a processor and a controller. Other processing configurations, such as parallel processors, are also possible.

The method according to the embodiment may be implemented in the form of program commands that may be executed through various computer means and recorded on a computer-readable medium. The computer-readable medium may include program commands, data files, data structures, etc., alone or in combination. The program commands recorded on the medium may be those specially designed and configured for the embodiment or may be those known to and available to those skilled in the art of computer software. Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program commands such as ROMs, RAMs, and flash memories. Examples of program instructions include machine language code, such as that produced by a compiler, as well as high-level language code that may be executed by a computer using an interpreter, etc. The hardware devices may be configured to operate as one or more software modules to perform the operations of the embodiments, and vice versa.

The software may include a computer program, code, instructions, or a combination of one or more of these. It may configure a processing device to perform a desired operation or, independently or collectively, command the processing device. The software and/or data may be permanently or temporarily embodied in any type of machine, component, physical device, virtual equipment, computer storage medium or device, or transmitted signal wave, for interpretation by the processing device or for providing instructions or data to the processing device. The software may be distributed over networked computer systems and stored or executed in a distributed manner. The software and data may be stored on one or more computer-readable recording media.

Although the embodiments have been described with limited drawings as described above, those skilled in the art may apply various technical modifications and variations based on the above. For example, even when the described techniques are performed in a different order than the described method, and/or the components of the described system, structure, device, circuit, etc. are combined or combined in a different form than the described method, or are replaced or substituted by other components or equivalents, appropriate results may be achieved.

Therefore, other implementations, other embodiments, and equivalents to the claims are also included in the scope of the claims described below.

1. An electronic device for performing a situation determination operation based on information about an object, the electronic device comprising:
a memory;
a processor; and
a camera;
wherein the processor directly processes an artificial intelligence model based on image processing, identifies information about the object by using an image of the object captured by the camera as an input to the artificial intelligence model based on image processing, and performs the situation determination operation based on the information about the identified object.

2. An electronic device for performing a situation determination operation based on information about an object, the electronic device comprising:
a memory;
a processor; and
a camera;
wherein the processor independently processes an artificial intelligence model based on image processing, identifies information about the object by using an image of the object captured by the camera as an input to the artificial intelligence model based on image processing, and performs the situation determination operation based on the information about the identified object.

3. An electronic device for performing a situation determination operation based on information about an object, the electronic device comprising:
a memory;
a processor; and
a camera;
wherein the electronic device is not a central control device on a network but a device installed locally to implement artificial intelligence-based control and/or processing, and
the processor processes an artificial intelligence model based on image processing, identifies information about the object by using an image of the object captured by the camera as an input to the artificial intelligence model, and performs the situation determination operation based on the information about the identified object.

4. The electronic device of claim 1, wherein the processor receives identification information and location information of a vehicle from the camera, and checks reservation information of the vehicle in response to the received identification information to generate route information and/or guidance information of the vehicle.

5. An electronic system for performing a situation determination operation based on information about an object, the electronic system comprising a first electronic device, a second electronic device, and a third electronic device of claim 4,
wherein a processor of the first electronic device receives information of a vehicle from a camera of the first electronic device, a processor of the second electronic device confirms a location of the vehicle from a camera of the second electronic device and a camera of the third electronic device, the camera of the third electronic device derives an image of the vehicle, and the processor of the third electronic device derives a final parking space of the vehicle based on the derived image.

6. The electronic device of claim 1, wherein the situation determination operation is performed such that the processor constructs a dataset through comparison and evaluation with a plurality of real data, learns using the constructed dataset, and estimates similarity with the image of the object captured by the camera.

7. The electronic device of claim 6, wherein the processor estimates similarity with the image of the object captured by the camera by applying a convolutional neural network.

8. The electronic device of claim 1, wherein the processor divides the image of the object captured by the camera into a plurality of blocks and performs an object detection process on the plurality of blocks.

9. The electronic device of claim 8, wherein the processor controls the camera to operate as a thermal imaging camera.

10. The electronic device of claim 8, wherein the processor identifies a person through the object detection process and transmits information indicating that the identified person is in a dangerous situation to the user terminal when a risk level of the block in which the identified person is located exceeds a preset threshold risk level.

11. The electronic device of claim 1, wherein the processor analyzes the image of the object captured by the camera to extract a gaseous cloud object and receives thermal image data from the camera when the processor determines that the gaseous cloud object is a true gas.

12. The electronic device of claim 1, wherein the processor constructs a dataset from standard traffic accident information, maps an image of the object of actual traffic accident information captured by the camera onto a two-dimensional flat map, compares the dataset with the actual traffic accident information, and estimates the standard traffic accident information similar to the actual traffic accident information.
